(19) United States
(12) Patent Application Publication
(10) Pub. No.: US 2009/0247296 A1
(43) Pub. Date: Oct. 1, 2009

(54) Gaming Apparatus Capable of Conversation with Player and Control Method Thereof

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/245,345

(22) Filed: Oct. 3, 2008

Related U.S. Application Data
(60) Provisional application No. 61/028,826, filed on Feb. 14, 2008.

(51) Int. Cl. A63F 13/00; G10L 15/18

(52) U.S. Cl. 463/31; 704/257; 463/35; 704/E15.003

(57) ABSTRACT

A gaming apparatus of the present invention comprises a microphone, a speaker, a display, and a controller programmed to conduct the processing of: (A) conducting a conversation with a player by recognizing a voice inputted from the microphone, in addition to outputting a voice relating to the conversation from the speaker by executing a conversation program; (B) measuring an elapsed time since the voice relating to the conversation is outputted from the speaker; (C) determining whether or not a response to the voice relating to the conversation is inputted from the microphone; and (D) conducting the conversation with the player by recognizing the voice inputted from the microphone, in addition to displaying to the display an image of sign language relating to the conversation, instead of conducting the processing (A), when the elapsed time exceeds a predetermined time without the response.

### CROSS-REFERENCE TO RELATED APPLICATIONS

This application claims priority of U.S. Provisional Application No. 61/028,826 filed on Feb. 14, 2008. The contents of this application are incorporated herein by reference in their entirety.

### BACKGROUND OF THE INVENTION

1. Field of the Invention

The present invention relates to a gaming apparatus capable of conducting a conversation with a player by executing a conversation program and a control method thereof.

2. Discussion of the Background

Conventionally, there exists a technology relating to a conversation program which enables recognition of a content of a voice inputted from a microphone and output of a voice response corresponding to the content. Technologies of this kind are disclosed in, for example, US 2007/0094007-A1, US 2007/0094008-A1, US 2007/0094005-A1, US 2007/0094004-A1 and US 2007/0033040-A1.

Objects of the present invention are to provide a sophisticated service by installing a conversation program of this kind on a gaming apparatus, and to provide a gaming apparatus which enables solving of a problem newly generated in the case that a conversation program is installed on a gaming apparatus and a control method thereof.

The contents of US 2007/0094007-A1, US 2007/0094008-A1, US 2007/0094005-A1, US 2007/0094004-A1 and US 2007/0033040-A1 are incorporated herein by reference in their entirety.

### SUMMARY OF THE INVENTION

The present invention provides a gaming apparatus having the following configuration.

Namely, the gaming apparatus comprises a microphone, a speaker, a display, and a controller. The controller is programmed to conduct the processing of: (A) conducting a conversation with a player by recognizing a voice inputted from the microphone, in addition to outputting a voice relating to the conversation from the speaker by executing a conversation program; (B) measuring an elapsed time period since the voice relating to the conversation is outputted from the speaker; (C) determining whether or not a response to the voice relating to the conversation is inputted from the microphone; and (D) conducting the conversation with the player by recognizing the voice inputted from the microphone, in addition to displaying to the display an image of sign language relating to the conversation, instead of conducting the processing (A), in the case that said elapsed time period exceeds a predetermined time period without said response determined to have been inputted in said processing (C).

According to the gaming apparatus, a conversation with the player is conducted based on the execution of a conversation program corresponding to the recognized language. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the gaming apparatus, it becomes possible to provide a sophisticated service by installing a conversation program on a gaming apparatus.

Further, according to the gaming apparatus, an elapsed time period since a voice relating to the conversation is outputted from the speaker is measured. Then, the gaming apparatus conducts the conversation with the player by recognizing a voice inputted from the microphone, in addition to displaying to the display an image of sign language relating to the conversation, instead of outputting a voice relating to the conversation from the speaker, in the case that a response to the voice relating to the conversation is not determined to be inputted and the elapsed time period exceeds a predetermined time period.

In the case that there is no response to the voice relating to the conversation outputted from the speaker over the predetermined time period, it is highly possible that the player does not hear the voice relating to the conversation. Namely, it is highly possible that the player has weak hearing. In the gaming apparatus, the conversation is conducted with such a player by displaying an image of sign language relating to the conversation to the display. Accordingly, it becomes possible even for a player with weak hearing to enjoy a conversation.

As above described, according to the gaming apparatus, it is possible to solve problems newly generated in the case that a conversation program is installed on a gaming apparatus, namely, a problem that how to recognize a player with weak hearing and a problem that how to entertain the player with weak hearing.

Furthermore, the gaming apparatus desirably comprises the following configuration.

The gaming apparatus comprises an input device and the controller is further programmed to conduct the processing of: (E) conducting the conversation with the player by recognizing the voice inputted from the microphone, in addition to displaying to the display the image of sign language relating to the conversation, instead of conducting the processing (A), in the case that there is an input to conduct the conversation by sign language from the input device.

Even among the players not with weak hearing, there may be a player who does not want another player to listen to the voice outputted from the gaming apparatus, although the player wants to enjoy the conversation. For example, there may be a case where the player is afraid that the voice of celebration outputted from the gaming apparatus on which the player plays might annoy a player on the next seat, when the game is going against the player on the next seat, so that the player cannot fully enjoy the conversation.

However, according to the above-mentioned gaming apparatus, in the case that there is an input to conduct the conversation by sign language from the input device, the controller conducts the conversation with the player by recognizing the voice inputted from the microphone, in addition to displaying an image of sign language relating to the conversation to the display instead of outputting the voice from the speaker. Accordingly, it becomes possible for the player to enjoy the conversation without having another player listen to the voice outputted from the gaming apparatus.

Moreover, the gaming apparatus desirably comprises the following configuration.

The gaming apparatus comprises an input device and the processing (D) includes: (D-1) displaying to the display a selection image to prompt the player to select whether or not to conduct the conversation by sign language, in the case that the elapsed time period exceeds the predetermined time period; and (D-2) conducting the conversation with the player by recognizing the voice inputted from the microphone, in addition to displaying to the display the image of sign language relating to the conversation, instead of conducting the processing (A), in the case that there is an input to conduct the conversation by sign language from the input device.

According to the gaming apparatus, a selection image to prompt the player to select whether or not to conduct the conversation by sign language is displayed to the display, in the case that a response to the voice relating to the conversation is not determined to be inputted and the elapsed time period exceeds a predetermined time period. Then, in the case that there is an input to conduct the conversation by sign language from the input device, the gaming apparatus conducts the conversation with the player by recognizing a voice inputted from the microphone, in addition to displaying an image of sign language relating to the conversation to the display, instead of outputting a voice from the speaker. Since the selection image to prompt the player to select whether or not to conduct the conversation by sign language is displayed to the display, the player with weak hearing can surely recognize that the conversation is conducted by sign language.

Moreover, the gaming apparatus desirably comprises the following configuration.

The gaming apparatus comprises a card reader capable of reading data from a removable card and the controller is further programmed to conduct the processing of (F) conducting the conversation with the player by recognizing the voice inputted from the microphone, in addition to displaying to the display the image of sign language relating to the conversation, instead of conducting the processing (A), when determining that specific data is read from the removable card through the card reader.

According to the gaming apparatus, in the case that specific data (for example, data indicating a weak hearing) is determined to be read from the removable card, the conversation with the player is conducted by recognizing a voice inputted from the microphone, in addition to displaying an image of sign language relating to the conversation to the display, instead of outputting a voice from the speaker.

Since the conversation by sign language is conducted in the case that the specific data is determined to be read from the removable card, the player with weak hearing can have the specific data read from the removable card so that the conversation by sign language is conducted. As a result, the player can surely enjoy the conversation.

The present invention further provides a gaming apparatus having the following configuration.

The gaming apparatus comprises a microphone, a speaker, a display, a card reader capable of reading data from a removable card, and a controller. The controller is programmed to conduct the processing of: (A) conducting a conversation with a player by recognizing a voice inputted from the microphone, in addition to outputting a voice relating to the conversation from the speaker by conducting a conversation program; (B) reading data from the removable card through the card reader; and (C) conducting the conversation with the player by recognizing the voice inputted from the microphone, in addition to displaying to the display an image of sign language relating to the conversation, instead of conducting the processing (A), when determining that the read data in the processing (B) is specific data.

According to the gaming apparatus, a conversation with the player is conducted based on the execution of a conversation program. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the gaming apparatus, it becomes possible to provide a sophisticated service by installing a conversation program on a gaming apparatus.

Further, in the case that a conversation program is installed on a gaming apparatus, there are generated problems that how to recognize a player with weak hearing and how to entertain the player with weak hearing. However, according to the gaming apparatus, in the case that specific data (for example, data indicating a weak hearing) is determined to be read from the removable card, the conversation with the player is conducted by recognizing a voice inputted from the microphone, in addition to displaying to the display an image of sign language relating to the conversation, instead of outputting a voice from the speaker.

Since the conversation by sign language is conducted in the case that the specific data is determined to be read from the removable card, the player with weak hearing can have the specific data read from the removable card so that the conversation by sign language is conducted. As a result, the player can surely enjoy the conversation.

The present invention further provides a gaming apparatus having the following configuration.

The gaming apparatus comprises a microphone, a speaker, a display, a camera for capturing a form and/or a motion of a hand of a player, and a controller. The controller is programmed to conduct the processing of: (A) conducting a conversation with the player by recognizing a voice inputted from the microphone, in addition to outputting a voice relating to the conversation from the speaker by conducting a conversation program; (B) measuring an elapsed time period since the voice relating to the conversation is outputted from the speaker; (C) determining whether or not a response to the voice relating to the conversation is inputted from the microphone; and (D) conducting the conversation with the player by recognizing the form and/or the motion of the hand of the player captured by the camera, in addition to displaying to the display an image of sign language relating to the conversation, instead of conducting the processing (A), in the case that said elapsed time period exceeds a predetermined time period without said response determined to have been inputted in said processing (C).

According to the gaming apparatus, a conversation with the player is conducted based on the execution of a conversation program. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the gaming apparatus, it becomes possible to provide a sophisticated service by installing a conversation program on a gaming apparatus.

Further, according to the gaming apparatus, an elapsed time period since the voice relating to the conversation is outputted from the speaker is measured. The gaming apparatus conducts the conversation with the player by recognizing a form and/or a motion of a hand of the player, in addition to displaying to the display an image of sign language relating to the conversation, instead of outputting the voice relating to the conversation, when the elapsed time period exceeds a predetermined time period.

In the case that there is no response to the voice relating to the conversation outputted from the speaker over the predetermined time period, it is highly possible that the player does not hear the voice relating to the conversation. Namely, it is highly possible that the player has weak hearing. In the gaming apparatus, the conversation is conducted to such a player by displaying an image of sign language relating to the conversation to the display. Accordingly, it becomes possible even for a player with weak hearing to enjoy a conversation.

As above described, according to the control method of the gaming apparatus, it is possible to solve problems newly generated in the case that a conversation program is installed on a gaming apparatus, namely, a problem that how to recognize a player with weak hearing and a problem that how to entertain the player with weak hearing.

The present invention further provides a gaming apparatus having the following configuration.

The gaming apparatus comprises a microphone, a speaker, a display, a card reader capable of reading data from a removable card, and a controller. The controller is programmed to conduct the processing of: (A) conducting a conversation with a player by recognizing a voice inputted from the microphone, in addition to outputting a voice relating to the conversation from the speaker by conducting a conversation program; (B) reading data from the removable card through the card reader; and (C) conducting the conversation with the player by recognizing a form and/or a motion of a hand of a player captured by a camera, in addition to displaying to the display an image of sign language relating to the conversation, instead of conducting the processing (A), in the case that the data read in the processing (B) is determined to be specific data.

According to the gaming apparatus, a conversation with the player is conducted based on the execution of a conversation program. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the gaming apparatus, it becomes possible to provide a sophisticated service by installing a conversation program on a gaming apparatus.

Further, in the case that a conversation program is installed on a gaming apparatus, there are generated problems that how to recognize a player with weak hearing and how to entertain the player with weak hearing. However, according to the gaming apparatus, in the case that specific data (for example, data indicating a weak hearing) is determined to be read from a removable card, the conversation with the player is conducted by recognizing a form and/or a motion of a hand of the player, in addition to displaying an image of sign language relating to the conversation, instead of outputting a voice from the speaker.

Since the conversation by sign language is conducted in the case that the specific data is determined to be read from the removable card, the player with weak hearing can have the specific data read from the removable card so that the conversation by sign language is conducted. As a result, the player can surely enjoy the conversation.

The present invention further provides a control method of a gaming apparatus having the following configuration.

Namely, the control method of a gaming apparatus, the control method comprises the step of: (A) conducting a conversation with a player by recognizing a voice inputted from a microphone, in addition to outputting a voice relating to the conversation from a speaker by executing a conversation program; (B) measuring an elapsed time period since the voice relating to the conversation is outputted from the speaker; (C) determining whether or not a response to the voice relating to the conversation is inputted from the microphone; and (D) conducting the conversation with the player by recognizing the voice inputted from the microphone, in addition to displaying to a display a text relating to the conversation, instead of conducting the processing (A), in the case that said elapsed time period exceeds a predetermined time period without said response determined to have been inputted in said step (C).

According to the control method of the gaming apparatus, a conversation with the player is conducted based on the execution of a conversation program. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the control method of the gaming apparatus, it becomes possible to provide a sophisticated service by installing a conversation program on a gaming apparatus.

Further, according to the control method of the gaming apparatus, an elapsed time period since a voice relating to the conversation is outputted from the speaker is measured. Then, the gaming apparatus conducts the conversation with the player by recognizing a voice inputted from the microphone, in addition to displaying to the display an image of sign language relating to the conversation, instead of outputting a voice relating to the conversation from the speaker, in the case that a response to the voice relating to the conversation is not determined to be inputted and the elapsed time period exceeds a predetermined time period.

In the case that there is no response to the voice relating to the conversation outputted from the speaker over the predetermined time period, it is highly possible that the player does not hear the voice relating to the conversation. Namely, it is highly possible that the player has weak hearing. In the gaming apparatus, the conversation is conducted with such a player by displaying an image of sign language relating to the conversation to the display. Accordingly, it becomes possible even for a player with weak hearing to enjoy a conversation.

As above described, according to the gaming apparatus, it is possible to solve problems newly generated in the case that a conversation program is installed on a gaming apparatus, namely, a problem that how to recognize a player with weak hearing and a problem that how to entertain the player with weak hearing.

The present invention further provides a control method of a gaming apparatus having the following configuration.

A control method of a gaming apparatus, the control method comprises the step of: (A) conducting a conversation with a player by recognizing a voice inputted from a microphone, in addition to outputting a voice relating to the conversation from a speaker by conducting a conversation program; (B) reading data from a removable card through a card reader; and (C) conducting the conversation with the player by recognizing the voice inputted from the microphone, in addition to displaying to a display a text relating to the conversation, instead of conducting the step (A), when determining that the read data in the step (B) is specific data.

According to the control method of the gaming apparatus, a conversation with the player is conducted based on the execution of a conversation program. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the control method of the gaming apparatus, it becomes possible to provide a sophisticated service by installing a conversation program on a gaming apparatus.

Further, in the case that a conversation program is installed on a gaming apparatus, there are generated problems that how to recognize a player with weak hearing and how to entertain the player with weak hearing. However, according to the gaming apparatus, in the case that specific data (for example, data indicating a weak hearing) is determined to be read from the removable card, the conversation with the player is conducted by recognizing a voice inputted from the microphone, in addition to displaying to the display an image of sign language relating to the conversation, instead of outputting a voice from the speaker.

Since the conversation by sign language is conducted in the case that the specific data is determined to be read from the removable card, the player with weak hearing can have the specific data read from the removable card so that the conversation by sign language is conducted. As a result, the player can surely enjoy the conversation.

As above described, according to the present invention, it is possible to provide a sophisticated service by installing a conversation program on a gaming apparatus, and to provide a gaming apparatus which enables solving of a problem newly generated in the case that a conversation program is installed on a gaming apparatus and a control method thereof.

### BRIEF DESCRIPTION OF THE DRAWINGS

FIG. 1 is a flow chart illustrating an outline of language type recognition processing conducted in a gaming apparatus according to one embodiment of the present invention.

FIG. 2 is an external view schematically showing a gaming system according to one embodiment of the present invention.

FIG. 3 is a block diagram illustrating an internal configuration of the gaming system shown in FIG. 2.

FIG. 4 is an exemplary view of an image displayed to a front display connected with a central controller.

FIG. 5 is a perspective view schematically showing the gaming apparatus shown in FIG. 2.

FIG. 6 is a block diagram illustrating an internal configuration of the gaming apparatus shown in FIG. 5.

FIG. 7 is an explanatory view of a storage area of a RAM provided in the gaming apparatus shown in FIG. 5.

FIG. 8 is an exemplary view of a GRADE image selection table.

FIG. 9 is an exemplary view of a conversation speed determination table.

FIG. 10 is an exemplary view of a displayable-or-not determination table.

FIG. 11 is an exemplary view of a conversational sentence selection table.

FIG. 12A is an exemplary view of an image displayed to a liquid crystal display provided in the gaming apparatus shown in FIG. 5.

FIG. 12B is another exemplary view of an image displayed to the liquid crystal display provided in the gaming apparatus shown in FIG. 5.

FIG. 13 is a flow chart illustrating game processing according to the present embodiment.

FIG. 14 is a flow chart illustrating game processing according to the present embodiment.

FIG. 15 is a flow chart illustrating game processing according to the present embodiment.

FIG. 16 is a flow chart illustrating game processing according to the present embodiment.

FIG. 17 is a flow chart illustrating game processing according to the present embodiment.

FIG. 18 is a flow chart illustrating game processing according to the present embodiment.

FIG. 19 is a flow chart illustrating language type recognition processing according to the present embodiment.

FIG. 20 is a flow chart illustrating language selection processing according to the present embodiment.

FIG. 21 is an exemplary view showing an image displayed to the liquid crystal display included in the gaming apparatus shown in FIG. 5.

FIG. 22 is a flow chart illustrating conversation mode selection processing according to the present embodiment.

FIG. 23 is an exemplary view showing an image displayed to the liquid crystal display included in the gaming apparatus shown in FIG. 5.

FIG. 24 is a flow chart illustrating belief estimation processing according to the present embodiment.

FIG. 25 is a flow chart illustrating conversation processing according to the present embodiment.

FIG. 26 is an exemplary view showing an image displayed to the liquid crystal display included in the gaming apparatus shown in FIG. 5.

### DESCRIPTION OF THE EMBODIMENTS

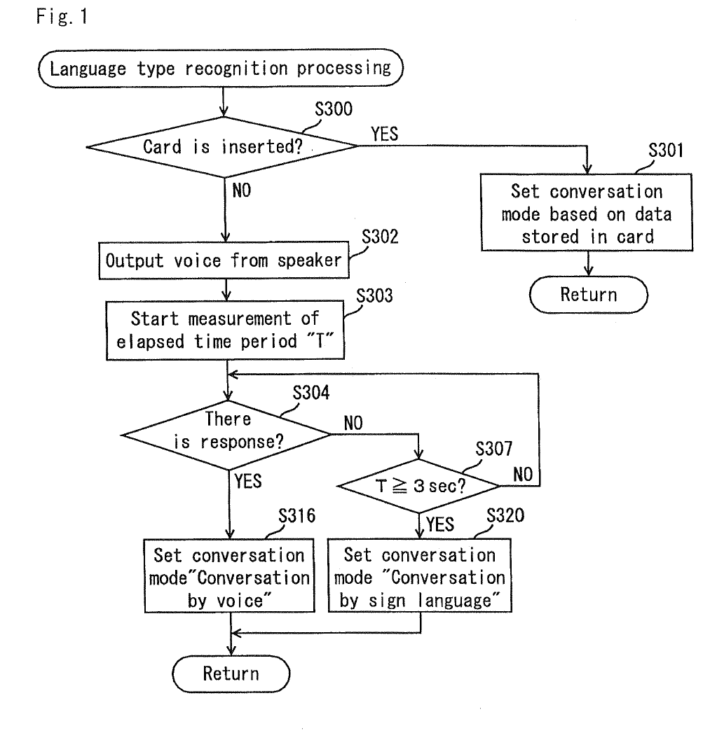

First, there will be described an outline of language type recognition processing conducted in a gaming apparatus according to an embodiment of the present invention with reference to FIG. 1.

FIG. 1 is a flow chart illustrating the outline of the language type recognition processing conducted in the gaming apparatus according to an embodiment of the present invention.

In the present embodiment, there will be described a case where Hold'em poker is played as a game. A rule of the Hold'em poker will be described later. Here, a type of the game conducted in the present invention is not particularly limited.

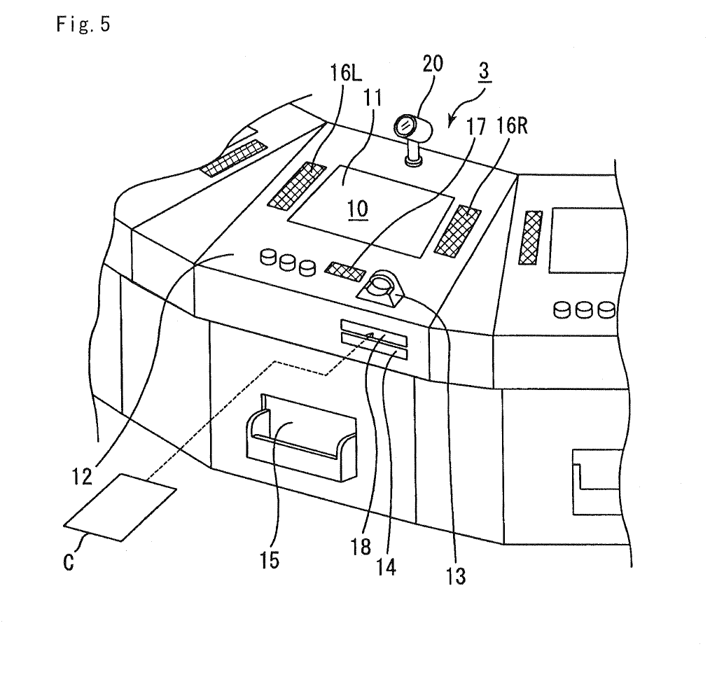

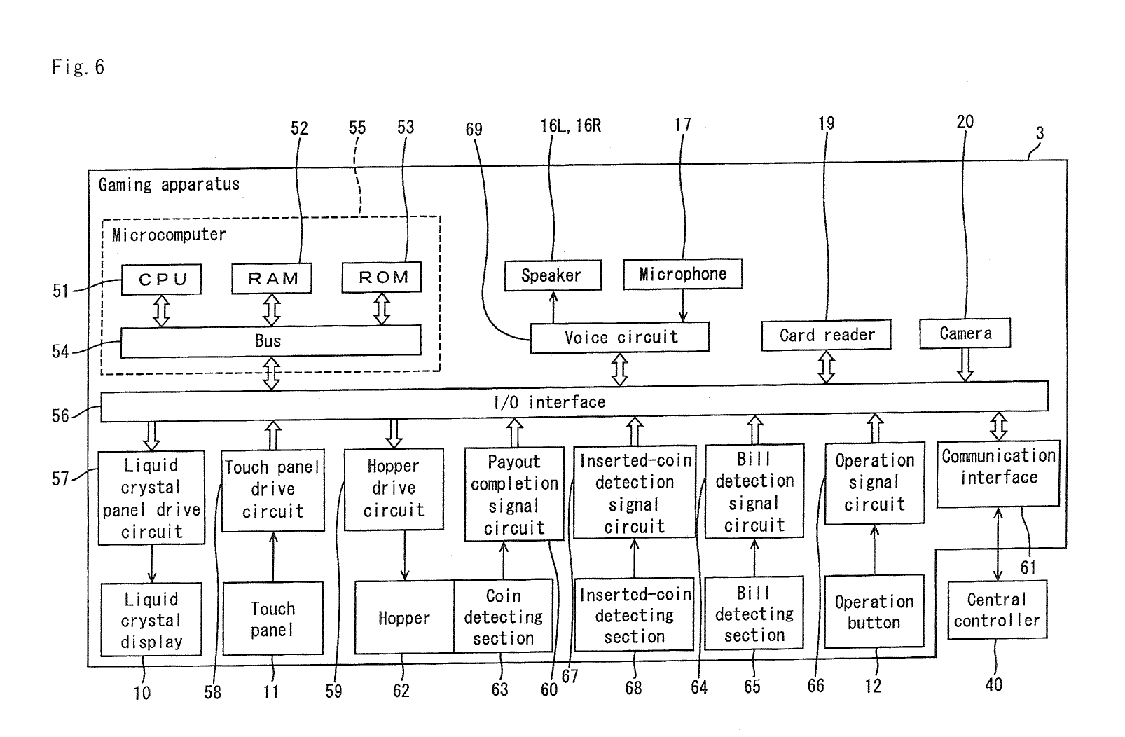

A CPU 51 (see FIG. 6) included in a gaming apparatus 3 determined whether or not a smart card is inserted in a card slot 18 (see FIG. 5) (step S300). When determining that the smart card is inserted, the CPU 51 sets in a RAM 52 (see FIG. 6) a conversation mode stored in the smart card and terminates the present subroutine.

The conversation mode is information for setting one of modes, out of a mode (1) conducting a conversation by recognizing a voice inputted from a microphone 17 (see FIG. 5), in addition to outputting a voice from speakers 16 (see FIG. 5) (hereinafter, also refers to as “conversation by voice”), a mode (2) conducting a conversation by recognizing a voice inputted from the microphone 17 or by recognizing sign language captured by a camera 20 (see FIG. 5), in addition to displaying to a liquid crystal display 10 an image of sign language relating to the conversation (hereinafter, also refers to as “conversation by sign language”) and a mode (3) not conducting a conversation (hereinafter, also refers to as “no conversation”).

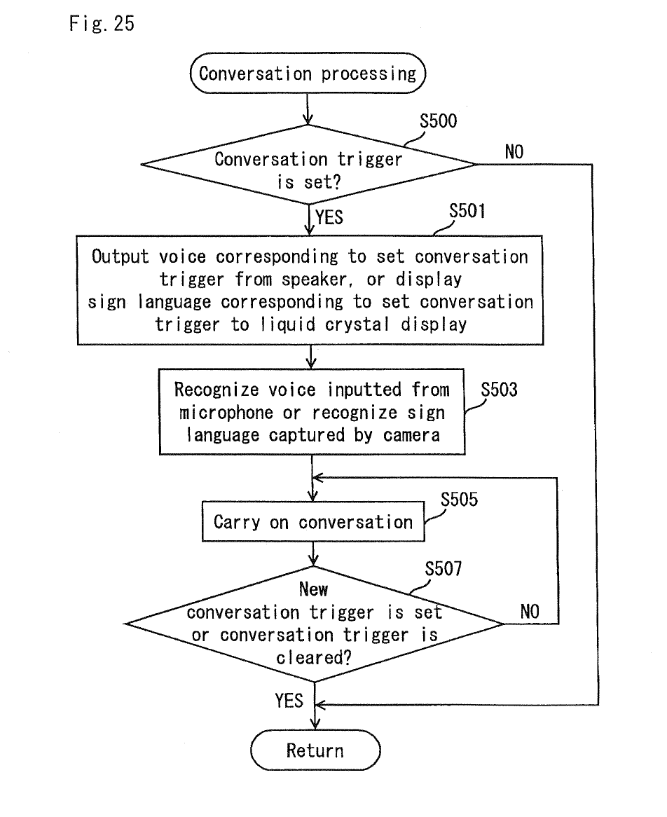

As a result of the conversation mode being set in the RAM 52, a conversation is conducted in the set mode in conversation processing (see FIG. 25)

When determining that the smart card is not inserted in step S300, in addition to outputting a voice such as “Hello” from the speakers 16 (step S302), the CPU 51 starts measuring an elapsed time period T (step S303).

Next, in step S304, the CPU 51 determines whether or not a response to “Hello” is inputted from the microphone 17. In the processing, the CPU 51 determines whether or not “Hello”, for example, is inputted from the microphone 17. When determining the response to “Hello” is inputted from the microphone 17, the CPU 51 sets the conversation mode “conversation by voice” in the RAM 52 (step S316) and terminates the present subroutine.

When determining that a response is not inputted in step S304, the CPU 51 determines whether or not the elapsed time period T exceeds three seconds (step S307). When determining that the elapsed time period T is not exceeding three seconds, the CPU 51 returns the processing to step S304.

When determining that the elapsed time period T is exceeding three seconds, the CPU 51 sets the conversation mode “conversation by sign language” in the RAM 52 (step S320) and terminates the present subroutine.

According to the gaming apparatus 3, the elapsed time period T since the voice relating to the conversation is outputted from the speakers 16 is measured. Then, the CPU 51 conducts the conversation with the player by recognizing a voice inputted from the microphone 17 or by recognizing the player's sign language captured by the camera 20, in addition to displaying to the liquid crystal display 10 an image of sign language relating to the conversation, instead of outputting a voice relating to the conversation from the speakers 16, in the case that a response to the voice relating to the conversation is not determined to be inputted and the elapsed time period T exceeds a predetermined time period (in the present embodiment, three seconds).

In the case that there is no response to the voice relating to the conversation outputted from the speakers 16 over the predetermined time period, it is highly possible that the player does not hear the voice relating to the conversation. Namely, it is highly possible that the player has weak hearing. In the gaming apparatus 3, the conversation is conducted to such a player by displaying an image of sign language relating to the conversation to the liquid crystal display 10. Accordingly, it becomes possible even for a player with weak hearing to enjoy a conversation.

As above described, according to the gaming apparatus 3, it is possible to solve problems newly generated in the case that a conversation program is installed on a gaming apparatus, namely, a problem that how to recognize a player with weak hearing and a problem that how to entertain the player with weak hearing.

Next, there will be described a gaming system according to an embodiment of the present invention in detail.

In a gaming system 1 according to the present embodiment, Hold'em poker is played as a game.

Here, a rule of Hold'em poker is described.

In Hold'em poker, a deck of playing cards (52 cards) except a joker is used.

First, a dealer deals two cards to each player. Each player selects an action after seeing the dealt cards, out of betting a coin (hereinafter, also simply refers to as “bet”), betting the same amount of coins as a bet amount of a previous player (hereinafter, also refers to as “call”), increasing a betting amount (hereinafter, also refers to as “raise”) and terminating the game without betting (hereinafter, also refers to as “fold”). In the following, this selection is referred to as a bet selection.

Next, the dealer opens three cards (called Flop) out of cards in hand. In the gaming system 1 according to the present embodiment, the Flop is displayed to a front display 21, as later described. Here, each player conducts the bet selection.

The dealer opens the fourth card (called Turn). Each player conducts the bet selection.

The dealer opens the fifth card (called River). Each player conducts the bet selection.

Then, all the cards (cards dealt at the beginning) in hands of the players remaining in the game are opened (called showdown), and then, each player forms a hand by combining two cards in hand and three cards out of five dealer's cards. Hands of the respective players are compared and all the betted coins are provided to the player who has established the strongest hand.

As hands in Hold' em poker, there are Royal Flush, Straight Flush, Four of a Kind, Full House, Flush, Straight, Three of a Kind, Two pair, One pair and No Pair, in the order of strength.

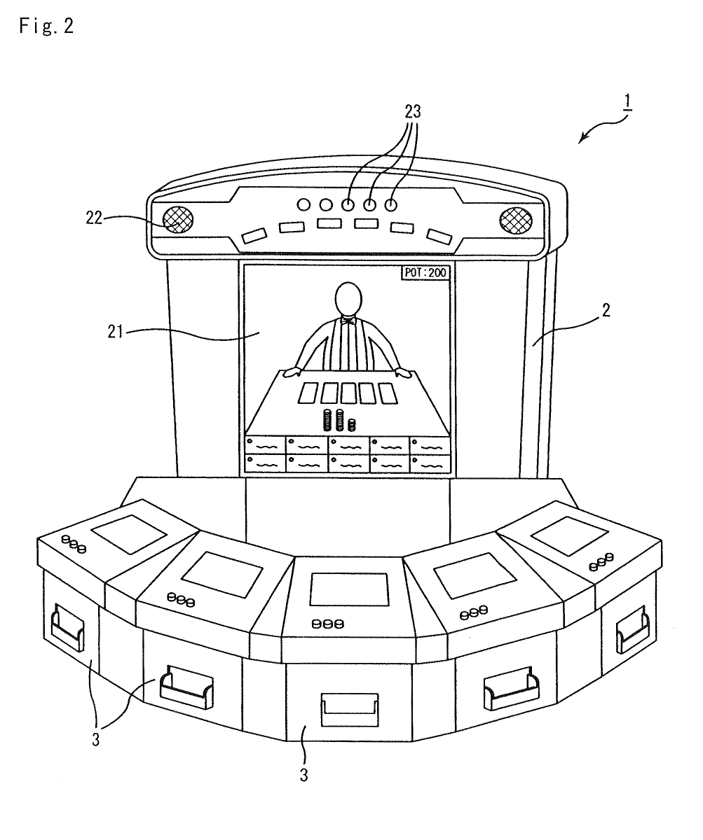

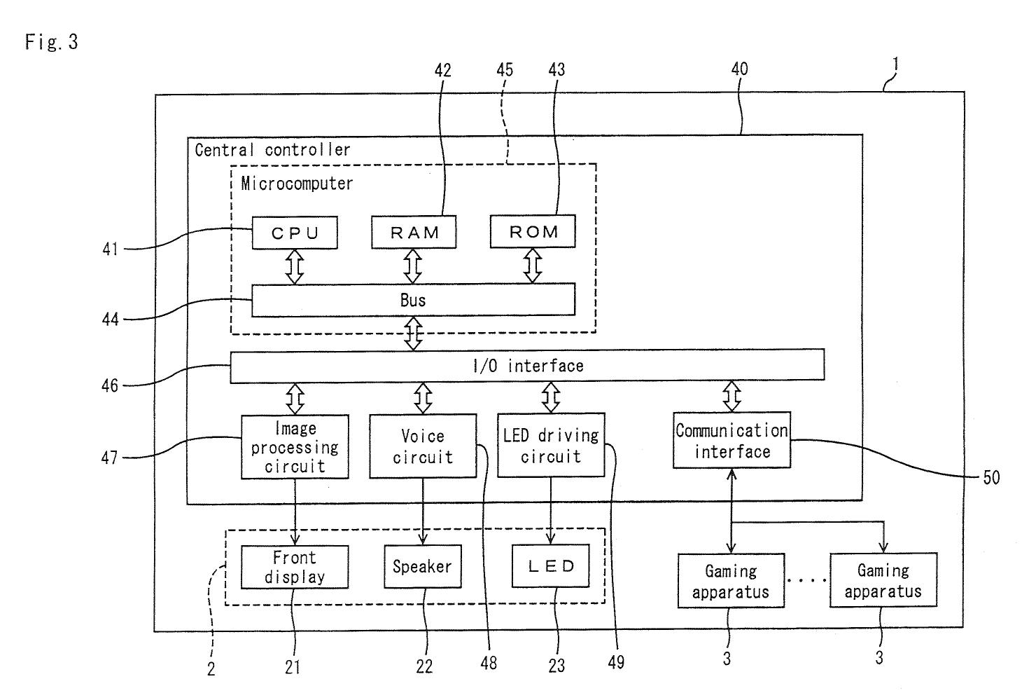

FIG. 2 is an external view schematically showing a gaming system according to an embodiment of the present invention. FIG. 3 is a block diagram illustrating an internal configuration of the gaming system shown in FIG. 2. Here, while the gaming apparatus 3 according to the present embodiment is connected to a network, the present invention is also applicable to a stand-alone type gaming apparatus which is not connected to a network.

The gaming system 1 according to the present embodiment is equipped with five gaming apparatuses 3 and a central controller 40 and a monitor 2. The monitor 2 is equipped with: a front display 21 for displaying an image of a dealer, information about each player's game (hereinafter, also referred to as gaming information) and the like; speakers 22 placed above the front display 21, for outputting music or an effect sound along with progress of the game; and LEDs 23 lighted when various types of effects are produced.

The central controller 40 basically comprises a microcomputer 45 as a core, which includes a CPU 41, a RAM 42, a ROM 43 and a BUS 44 for transferring data mutually among these devices.

The ROM 43 stores various types of programs for conducting processing necessary for controlling the gaming system 1, a data table and the like. Further, the RAM 42 is a memory for temporarily storing various types of data calculated in the CPU 41.

The CPU 41 is connected through an I/O interface 46 with an image processing circuit 47, a voice circuit 48, a LED drive circuit 49 and a communication interface 50. The front display 21 is connected with the image processing circuit 47. The speakers 22 are connected with the voice circuit 48. The LEDs 23 are connected with the LED drive circuit 49. Five gaming apparatuses 3 are connected with the communication interface 50. The central controller 40 controls output of a signal relating to an image to be displayed to the front display 21, and driving of the speakers 22 and the LEDs 23.

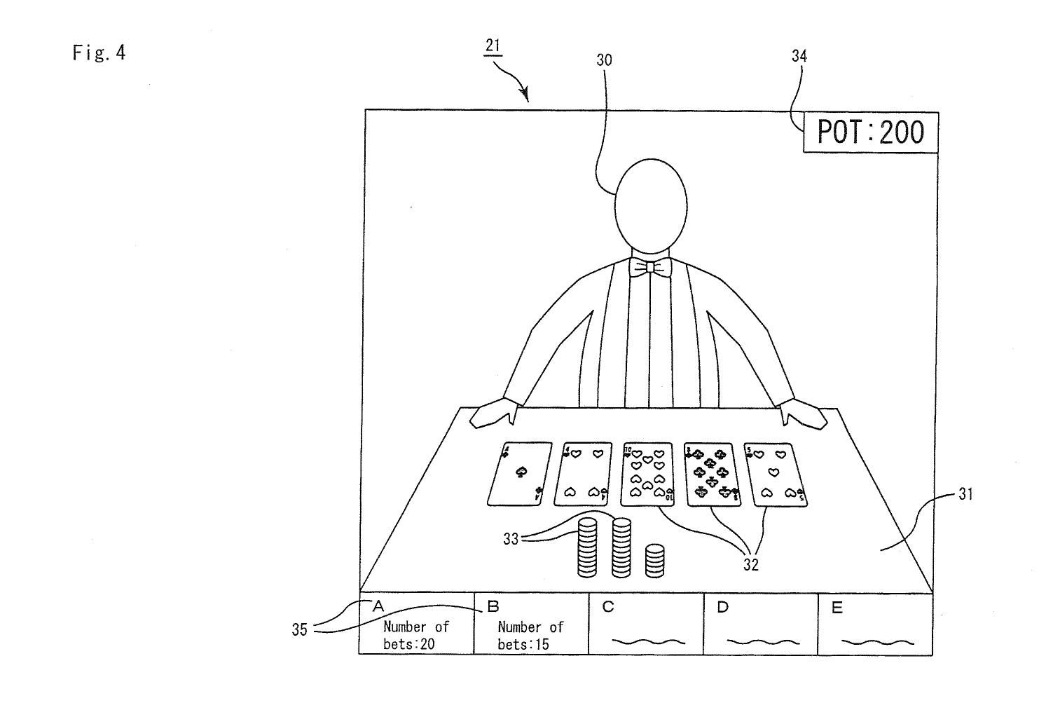

FIG. 4 is an exemplary view of an image displayed to a front display.

As illustrated in FIG. 4, a dealer 30 is displayed to a virtually central part of the front display 21.

Below the dealer 30, a table 31 is displayed. On the table 31, there are displayed five card images 32 indicating five cards and a coin image 33 indicating betted coins.

Further, below the table 31, there are provided gaming information display portions 35 for displaying respective players' gaming information. Alphabets A to E displayed to the gaming information display portions 35 correspond to the respective gaming apparatuses 3. To each of the gaming information display portions 35, there is displayed the gaming information of the player on the corresponding gaming apparatus 3.

The gaming information includes information on the number of bets placed until now and a bet selection of each player. Further, in the case of showdown, cards dealt to each player at the beginning of the game are displayed to the gaming information display portion 35.

Here, in the case that there is a gaming apparatus 3 not used for the game, the gaming information of the player having a turn to select a bet is displayed to the gaming information display portion 35 corresponding to the gaming apparatus 3.

At the upper right end part of the front display 21, there is provided a POT display portion 34 for displaying a total sum of coins betted at the moment.

FIG. 5 is a perspective view schematically showing the gaming apparatus shown in FIG. 2.

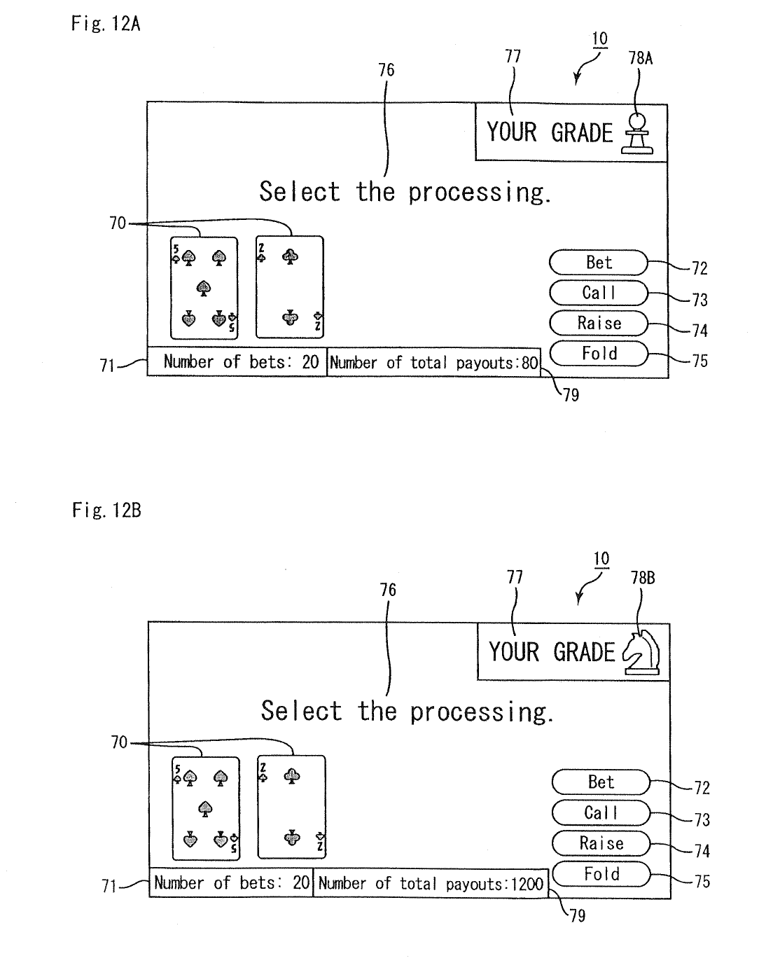

As illustrated in FIG. 5, the gaming apparatus 3 is equipped with a liquid crystal display 10 for displaying an image related to a later-described operation (see FIG. 12A), a result of a game and the like, in the virtually center part of the upper face thereof. The liquid crystal display 10 corresponds to the display according to the present invention. On the upper face of the liquid crystal display 10, there is provided a touch panel 11 with which a player inputs an operation. In front of the liquid crystal display 10, there are provided an operation button 12 with which a payout operation is performed, a coin insertion slot 13 to which a coin or a medal is inserted and a microphone 17 for picking up a voice of the player. On both sides of the liquid crystal display 10, there are provided speakers 16 (speaker 16L, speaker 16R). The microphone 17 corresponds to the microphone according to the present invention. The speakers 16 correspond to the speaker of the present invention. Further, at the upper right end of the front face of the gaming apparatus 3, there are provided a card slot 18 to which a smart card C is inserted and a bill insertion slot 14 to which a bill is inserted. Below the bill insertion slot 14, there is provided a coin payout exit 15 for paying out to the player a coin or a medal corresponding to the accumulated credit when the payout operation is conducted.

Further, to the back side of the upper face of the gaming apparatus 3, the camera 20 for capturing the player's sign language is provided.

Next, there will be described an internal configuration of the gaming apparatus 3.

FIG. 6 is a block diagram illustrating an internal configuration of a gaming apparatus according to the present embodiment.

As illustrated in FIG. 6, the gaming apparatus 3 basically comprises a microcomputer 55 as a core, which includes the CPU 51, the RAM 52, a ROM 53 and a BUS 54 for transferring data mutually among these devices.

The ROM 53 stores various types of programs for conducting processing necessary for controlling the gaming apparatus 3, a data table and the like. Particularly, the ROM 53 stores a language recognition program for recognizing a language type and a conversation program for conducting a conversation with a player. As the language recognition program and the conversation program, conventionally known programs may be adopted. Here, the language recognition program and the conversation program are disclosed in US 2007/0094007-A1, US 2007/0094008-A1, US 2007/0094005-A1, US 2007/0094004-A1 and US 2007/0033040-A1, and therefore, detailed descriptions thereof are omitted here.

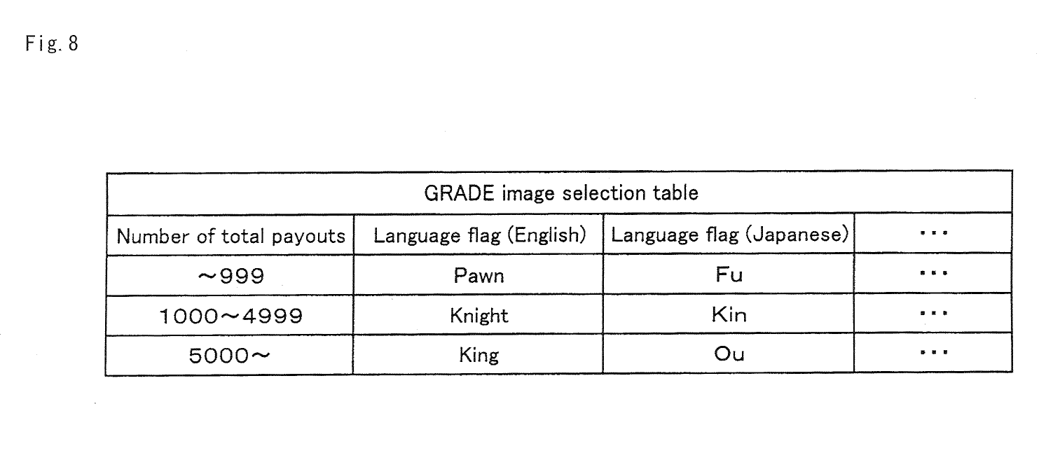

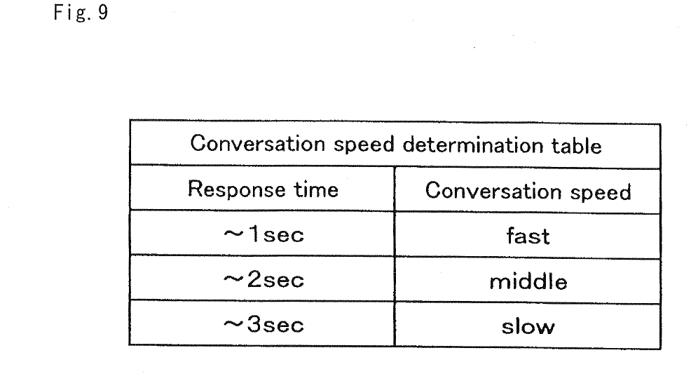

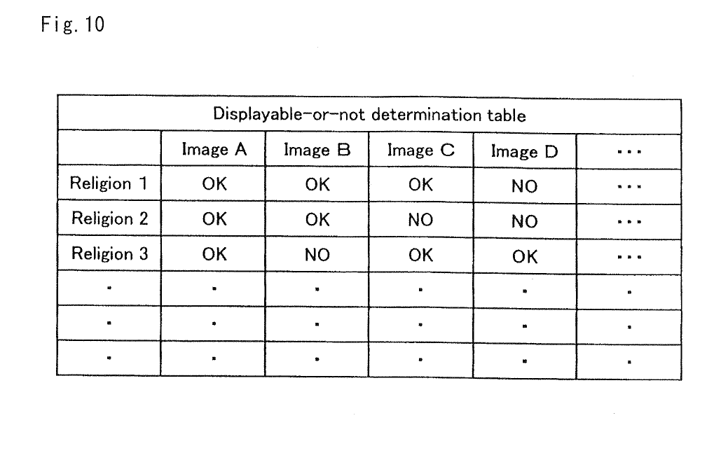

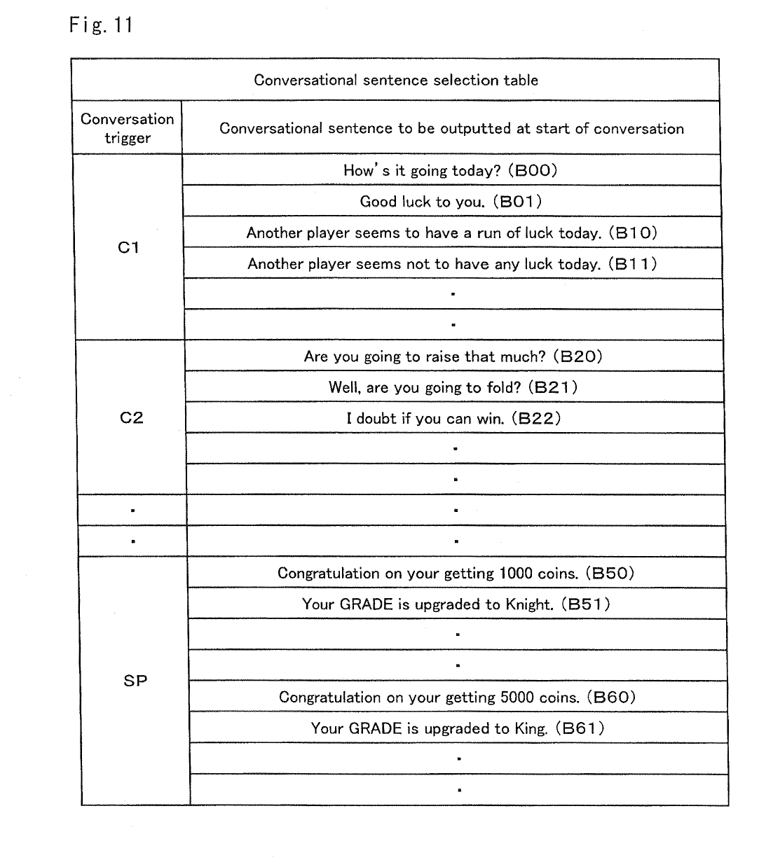

Further, the ROM 53 particularly stores a GRADE image selection table (see FIG. 8), a conversation speed determination table (see FIG. 9), a displayable-or-not determination table (see FIG. 10) and a conversational sentence selection table (see FIG. 11). Here, details of these tables will be described later. Furthermore, the ROM 53 stores image data, such as a text image and a language selection image, corresponding to the language type. The ROM 53 further stores effect image data, which is for displaying a GRADE image and corresponding to the language type. The ROM 53 further stores voice data and text data, which are relating to the conversation and corresponding to the language type.

Further, the ROM 53 stores a program for recognizing the player's sign language by motion capture using the image captured by the camera 20. Here, a technology for recognizing the player's sign language by motion capture using the image captured by the camera is disclosed in, for example, U.S. Pat. No. 6,549,887 and in U.S. Pat. No. 5,659,764, and therefore, a detailed description thereof is omitted here.

Moreover, the CPU 51, the RAM 52 and the ROM 53 configure the controller of the present invention.

The RAM 52 is a memory capable of temporarily storing the number of credits accumulated in the gaming apparatus 3 at the moment and a various types of data calculated in the CPU 51.

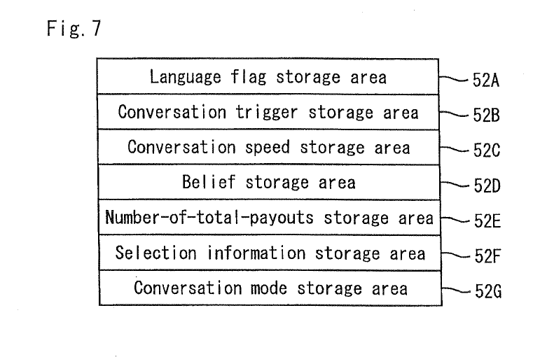

FIG. 7 is an explanatory view of a storage area of a RAM provided in the gaming apparatus shown in FIG. 5.

As illustrated in FIG. 7, the RAM 52 is particularly provided with a language flag storage area 52A for storing a language flag, a conversation trigger storage area 52B for storing a conversation trigger, a conversation speed storage area 52C for storing information on conversation speed, a belief storage area 52D for storing information on an estimated belief of a player, a number-of-total-payouts storage area 52E for storing the number of total payouts, a selection information storage area 52F for storing information on bet selection (hereinafter, also referred to as “selection information”) and a conversation mode storage area 52G for storing a conversation mode.

Further, as illustrated in FIG. 6, the CPU 51 is connected through an I/O interface 56 with a liquid crystal panel drive circuit 57, a touch panel drive circuit 58, a hopper drive circuit 59, a payout completion signal circuit 60, an inserted-coin detection signal circuit 67, a bill detection signal circuit 64, an operation signal circuit 66, a communication interface 61, a voice circuit 69, a card reader 19 and a camera 20.

The liquid crystal display 10 is connected with the liquid crystal panel drive circuit 57. The touch panel 11 is connected with the touch panel drive circuit 58. A hopper 62 is connected with the hopper drive circuit 59. A coin detecting section 63 is connected with the payout completion signal circuit 60. An inserted-coin detecting section 68 is connected with the inserted-coin detection signal circuit 67. A bill detecting section 65 is connected with the bill detection signal circuit 64. The operation button 12 is connected with the operation signal circuit 66. The speakers 16 and the microphone 17 are connected with the voice circuit 69.

The hopper 62 is provided inside the gaming apparatus 3 and pays out a coin from the coin payout exit 15 based on a control signal outputted from the CPU 51.

The coin detecting section 63 is provided inside the coin payout exit 15 and transmits a signal to the CPU 51 on detecting a predetermined number of coins being paid out through the coin payout exit 15.

The inserted-coin detecting section 68, on detecting a coin being inserted from the coin insertion slot 13, detects the value of the coin and transmits to the CPU 51 a detection signal indicating the detected value.

The bill detecting section 65, on accepting a bill, detects the value of the bill and transmits to the CPU 51 a detection signal indicating the detected value.

The operation button 12 is a button with which a payout operation is performed in the case that a payout of a coin is determined.

The card reader 19 transmits to the main CPU 41 data read from the smart card C and writes data into the smart card C based on a control signal from the main CPU 41.

FIG. 8 is an exemplary view of a GRADE image selection table.

As illustrated in FIG. 8, the GRADE image is determined based on a combination of the number of total payouts and the language flag. For example, in the case that the language flag is “English” and the number of total payouts is 999 or less, “Pawn” is selected as the GRADE image. Further, in the case that the language flag is “English” and the number of total payouts is in the range of 1000 to 4999, “Knight” is selected as the GRADE image. Furthermore, in the case that the language flag is “English” and the number of total payouts is 5000 or more, “King” is selected as the GRADE image.

On the other hand, for example, in the case that the language flag is “Japanese” and the number of total payouts is 999 or less, “Fu” is selected as the GRADE image. Further, in the case that the language flag is “Japanese” and the number of total payouts in the range of 1000 to 4999, “Kin” is selected as the GRADE image. Furthermore, in the case that the language flag is “Japanese” and the number of total payouts is 5000 or more, “Ou” is selected as the GRADE image.

The GRADE image in the present embodiment corresponds to the effect image according to the present invention.

FIG. 9 is an exemplary view of a conversation speed determination table.

As illustrated in FIG. 9, the conversation speed is determined according to the response time between the output of the voice relating to the conversation from the speakers 16 and the input of a response thereto from the microphone 17. For example, in the case that the response time is one second or less, the conversation speed is determined to be “fast”. Further, in the case that the response time is over one second and not over two seconds, the conversation speed is determined to be “middle”. Furthermore, the response time is over two seconds and not over three seconds, the conversation speed is determined to be “slow”.

FIG. 10 is an exemplary view of a displayable-or-not determination table.

As illustrated in FIG. 10, in the displayable-or-not determination table, each religion is related to whether or not respective images (image A, image B, image C and image D) are displayable. For example, religion 1 is related to “OK” with respect to the display of the image A, the image B and the image C, and is related to “NO” with respect to the display of the image D.

FIG. 11 is an exemplary view of a conversational sentence selection table.

As illustrated in FIG. 11, a conversational sentence outputted at the start of a conversation is stored in a state being related to the conversation trigger. In the present embodiment, a plurality of conversational sentences are related to a single type of conversation trigger.

A conversation trigger C1 is a trigger set in the RAM 52 when the to-be-dealt cards are displayed.

A conversation trigger C2 is a trigger set in the RAM 52 when the player takes an action out of bet, call, raise and fold, after to-be-dealt cards are displayed.

A conversation trigger C3 is a trigger set in the RAM 52 when the player takes an action out of bet, call, raise and fold, after Flop is displayed.

A conversation trigger C4 is a trigger set in the RAM 52 when the player takes an action out of bet, call, raise and fold, after Turn is displayed.

A conversation trigger SP is a trigger indicating that the number of total payouts becomes equal to or more than the predetermined number (in the present embodiment, 1000 or more, or 5000 or more), and is a trigger set in the RAM 52 when a single game is ended.

In the case that the conversation trigger C1 is set, the CPU 51 determines a single conversational sentence as a to-be-outputted conversational sentence by selecting a random number, out of general conversational sentences (for example, a conversational sentence BOO and a conversational sentence B01) and conversational sentences based on a gaming history on another gaming apparatus 3 (for example, a conversational sentence B10 and a conversational sentence B11). Here, the gaming history on another gaming apparatus 3 is received from the central controller 40 at a predetermined timing (for example, every time a single game is ended). Examples of the gaming history received from the central controller 40 include the number of coins paid out in each gaming apparatus 3.

In the case that the conversation trigger C2 is set, the CPU 51 refers to the selection information and determines a conversational sentence corresponding to the selection information as a to-be-outputted conversational sentence. For example, the CPU 51 selects a conversational sentence B20 in the case that the selection information is “raise”, a conversational sentence B21 in the case that the selection information is “fold”, and a conversational sentence B22 in the case that the selection information is other than “raise” and “fold”, as a to-be-outputted conversational sentence.

In the case that the conversation trigger SP is set, the CPU 51 refers to the number of total payouts stored in the number-of-total-payouts storage area 52E and determines a conversational sentence corresponding to the number of total payouts. For example, the CPU 51 selects a conversational sentence B50 or a conversational sentence B51 in the case that the number of total payouts is equal to or more than 1000 (equal to or less than 4999), and a conversational sentence B60 or a conversational sentence B61 in the case that the number of total payouts is equal to or more than 5000, as a to-be-outputted conversational sentence.

FIG. 12A and FIG. 12B are exemplary views of images displayed to a liquid crystal display provided in a gaming apparatus.

Here, images shown in FIG. 12A and FIG. 12B are images displayed to the liquid crystal display in the case that “English” is set as the language flag.

As illustrated in FIG. 12A, to the upper right side of the liquid crystal display 10, a text image 77 showing “YOUR GRADE” and a GRADE image 78A showing a Pawn piece of chess are displayed.

In the left side of the liquid crystal display 10, two card images 70 showing two cards to be dealt to the player at the beginning of the game are displayed.

Under the card images 70, there are provided a number-of-bets display portion 71 for displaying the number of bets of the player at the moment and a number-of-total-payouts display portion 79 for displaying the total number of coins paid out to the player in the past games, starting from the left.

In the right side of the liquid crystal display 10, there are provided a bet selecting portion 72 for selecting “bet”, a call selecting portion 73 for selecting “call”, a raise selecting portion 74 for selecting “raise” and a fold selecting portion 75 for selecting “fold”, when a bet selection is conducted. The player can conduct a bet selection by touching a part corresponding to each selecting portion on the touch panel 11.

To the center part of the liquid crystal display 10, there is displayed an instruction image 76 showing “Select the processing.” to prompt the player to conduct a bet selection.

In the case that the number of total payouts is 999 or less, as illustrated in FIG. 12A, the GRADE image 78A showing the Pawn piece is displayed as the GRADE image. On the other hand, in the case that the number of total payouts is in the range of 1000 to 4999, as illustrated in FIG. 12B, a GRADE image 78B showing a Knight piece is displayed as the GRADE image. Further, although not shown, in the case that the number of total payouts is 5000 or more, a GRADE image showing a King piece is displayed as the GRADE image.

Next, there will be described game processing conducted in the gaming system 1.

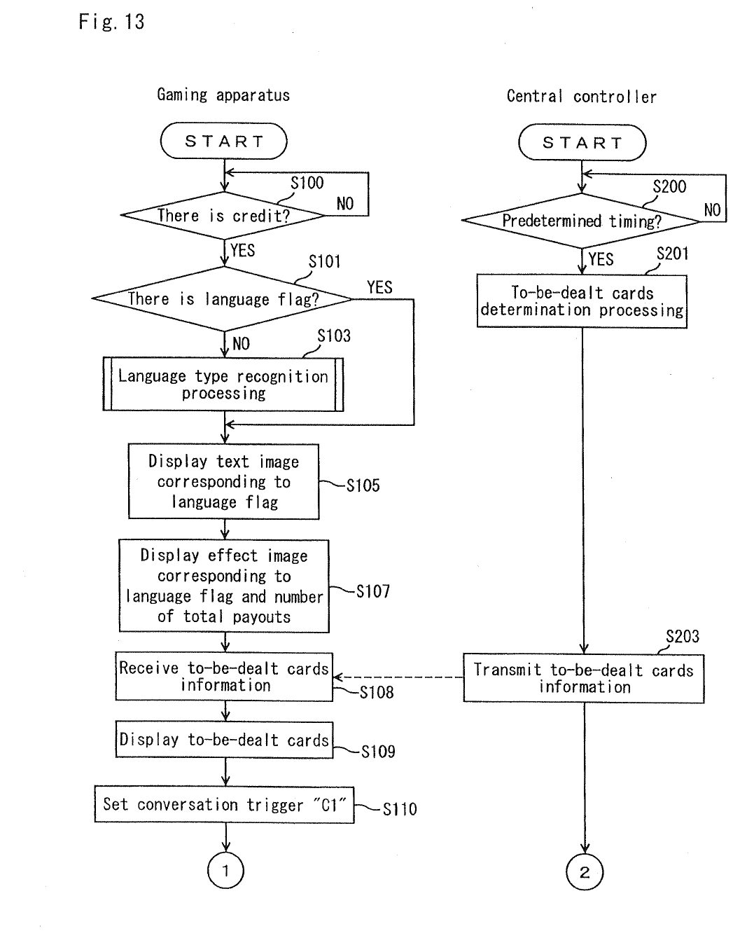

FIGS. 13 to 18 are flow charts illustrating game processing according to the present embodiment.

First, the CPU 51 determines whether or not there is remaining a credit (step S100). When determining that there is not remaining the credit, the CPU 51 returns the processing to step S100. Here, in the present embodiment, a coin can be inserted to the coin insertion slot 13 at an optional timing. When determining that the inserted-coin detecting section 68 detects a coin, the CPU 51 stores a credit corresponding to the inserted coin by adding to the credit being stored in the RAM 52.

When determining that there is remaining the credit in step S100, the CPU 51 determines whether or not the language flag is set (step S101).

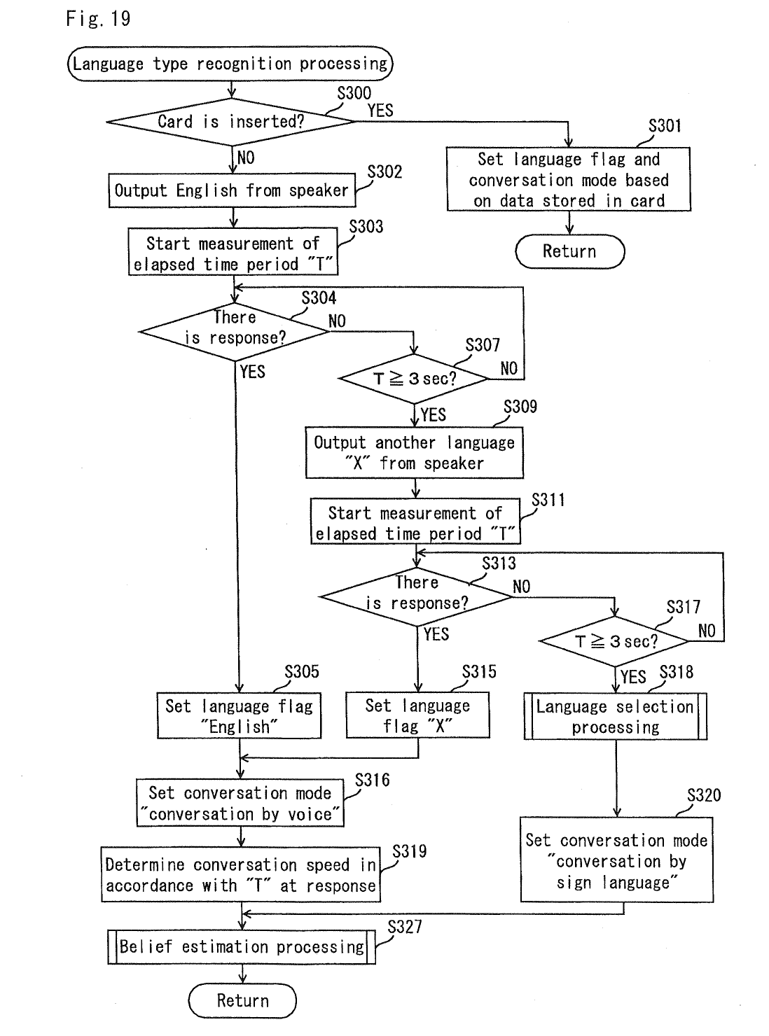

When determining that the language flag is not set, the CPU 51 conducts the language type recognition processing (step S103). In the processing, the CPU 51 outputs various languages such as English and Japanese from the speakers 16 (see FIG. 5) one by one. Then, the CPU 51 determines to which language there is a response from the microphone 17 (see FIG. 5), and thereby determining a language type. Thereafter, a language flag corresponding to the determined language type is set in the RAM 52. Here, a detail of the language type recognition processing will be described later with reference to FIG. 19.

When determining that the language flag is not set in step S101 or after conducting the processing of step S103, the CPU 51 displays a text image corresponding to the language flag to the liquid crystal display 10 (step S105). In the processing, for example, the CPU 51 displays the text image 77 (for example, see FIG. 12A) in English in the case that the language flag is “English”, and displays the text image in Japanese in the case that the language flag is “Japanese”.

Next, in step S107, the CPU 51 displays an effect image corresponding to the language flag to the liquid crystal display 10. In the processing, for example, the CPU 51 displays an image of a chess piece (for example, see the GRADE image 78A in FIG. 12A) in the case that the language flag is “English”, and displays an image of a shogi piece in the case that the language flag is “Japanese”. As above described, the CPU 51 reads image data corresponding to the language flag and displays an image based on the read image data to the liquid crystal display 10.

At this time, the CPU 51 displays various images to the liquid crystal display 10 according to the number of total payouts. More specifically, in the case that the language flag is “English” and the number of total payouts is 999 or less, for example, the CPU 51 displays a GRADE image (see the GRADE image 78A in FIG. 12A) showing the Pawn piece as the GRADE image. Further, in the case that the language flag is “English” and the number of total payouts is in the range of 1000 to 4999, the CPU 51 displays a GRADE image (see the GRADE image 78B in FIG. 12 B) showing the Knight piece as the GRADE image.

Furthermore, in the case that the language flag is “English” and the number of total payouts is 5000 or more, the CPU 51 displays a GRADE image showing the King piece as the GRADE image.

As above described, the CPU 51 varies a type of a chess piece to be displayed as the GRADE image according to the number of total payouts, in the case that the language flag is “English”.

On the other hand, in the case that the language flag is “Japanese” and the number of total payouts is 999 or less, for example, the CPU 51 displays a GRADE image showing “Fu” of a shogi piece as the GRADE image.

Further, in the case that the language flag is “Japanese” and the number of total payouts is in the range of 1000 to 4999, the CPU 51 displays a GRADE image showing “Kin” of a shogi piece as the GRADE image.

Furthermore, in the case that the language flag is “Japanese” and the number of total payouts is 5000 or more, the CPU 51 displays a GRADE image showing “Ou” as the GRADE image.

After the processing of step S107, the CPU 51 waits for receiving to-be-dealt cards information from the CPU 41 included in the central controller 40. The to-be-dealt cards information is information on two cards to be dealt to the player and includes numbers or alphabets, and suits.

The CPU 41 included in the central controller 40 determines two cards to be dealt to the player, that is, the to-be-dealt cards information to be transmitted to each gaming apparatus 3, by using a random number, when a predetermined timing (for example, a timing that one minute has elapsed since the last game is ended) has come (step S201).

Next, the CPU 41 transmits the to-be-dealt cards information determined in step S201 to each gaming apparatus 3 (step S203).

On the other hand, the CPU 51 included in the gaming apparatus 3 displays, upon receiving the to-be-dealt cards information from the CPU 41 in the central controller 40 (step S108), two cards to the liquid crystal display 10 based on the received to-be-dealt cards information in step S109 (for example, see FIG. 12A).

Next, in step S111, the CPU 51 sets the conversation trigger C1 in the RAM 52. As a result of the conversation trigger C1 being set in the RAM 52, a conversation based on the to-be-dealt cards being dealt is started in the gaming apparatus 3. Here, processing relating to the conversation will be described later with reference to FIG. 25.

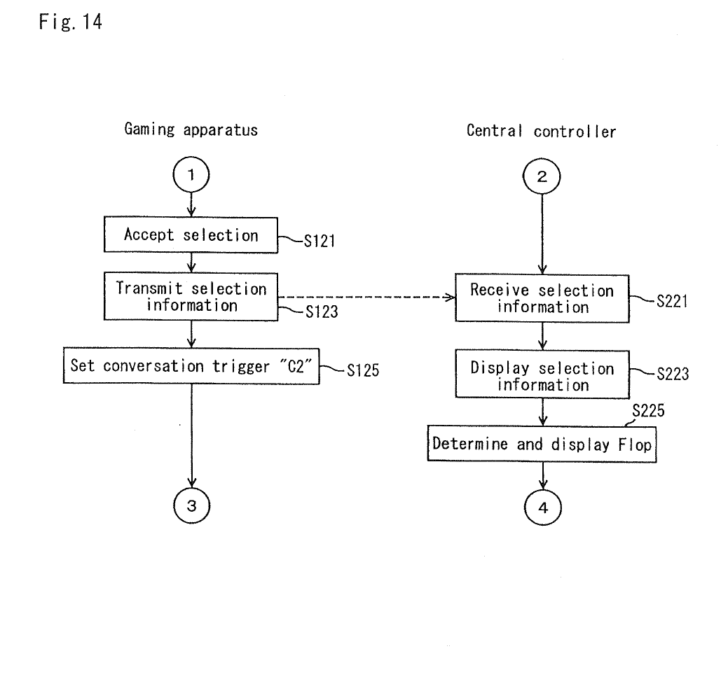

Next, in step S121 in FIG. 14, the CPU 51 accepts the bet selection. In this step, the player conducts a bet selection on the touch panel 11.

In step S123, the CPU 51 conducts processing of subtracting a credit corresponding to the betted coin from the credit being stored in the RAM 52, concurrently with transmitting information on the bet selection inputted by the player (selection information) to the CPU 41. The selection information includes information on the number of coins betted by the player.

In step S125, the CPU 51 sets the conversation trigger C2 in the RAM 52. As a result of the conversation trigger C2 being set in the RAM 52, a conversation based on the player's selection of bet, call, raise or fold is started in the gaming apparatus 3.

On the other hand, the CPU 41 included in the central controller 40 displays, upon receiving the selection information transmitted from the CPU 51 (step S221), the received selection information to the gaming information display portion 35 in the front display 21 (step S223), and cumulatively adds the number of credits corresponding to the betted coins to the number of credits stored in the RAM 42. Next, the CPU 41 determines three cards, which are to be Flop, and displays the cards to the front display 21 (step S225).

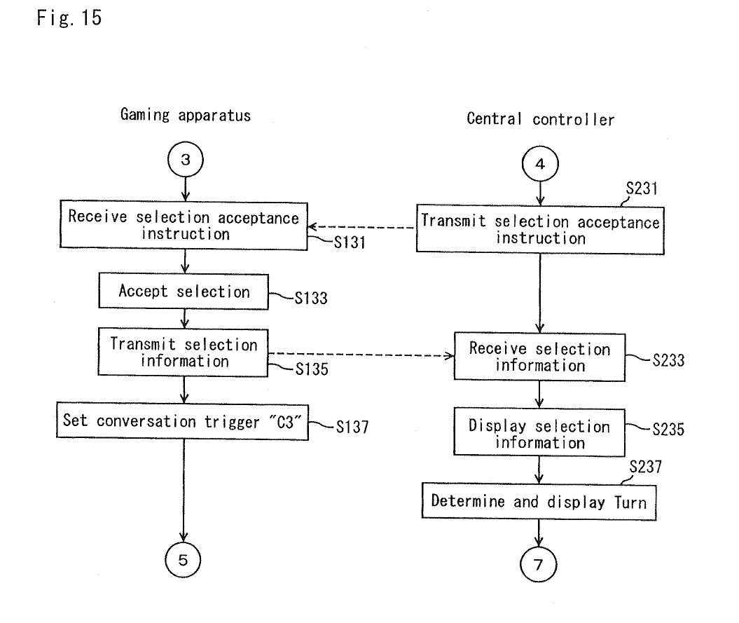

Next, in step S231 in FIG. 15, the CPU 41 transmits to the CPU 51 a signal for instructing an acceptance of the bet selection (selection acceptance instruction signal).

On receiving the selection acceptance instruction signal (step S131 in FIG. 15), the CPU 51 included in the gaming apparatus 3 accepts the bet selection (step S133), transmits the selection information to the CPU 41 (step S135) and subtracts a credit corresponding to the betted coin from the credit being stored in the RAM 52.

Next, in step S137, the CPU 51 sets the conversation trigger C3 in the RAM 52. As a result of the conversation trigger C3 being set in the RAM 52, a conversation based on the player's selection of bet, call, raise or fold is started in the gaming apparatus 3.

On the other hand, upon receiving the selection information transmitted from the CPU 51 (step S233), the CPU 41 included in the central controller 40 displays the received selection information to the gaming information display portion 35 in the front display 21 (step S235), and cumulatively adds the number of credits corresponding to the betted coins to the number of credits stored in the RAM 42. Next, the CPU 41 determines a card, which is to be Turn, and displays the card to the front display 21 (step S237).

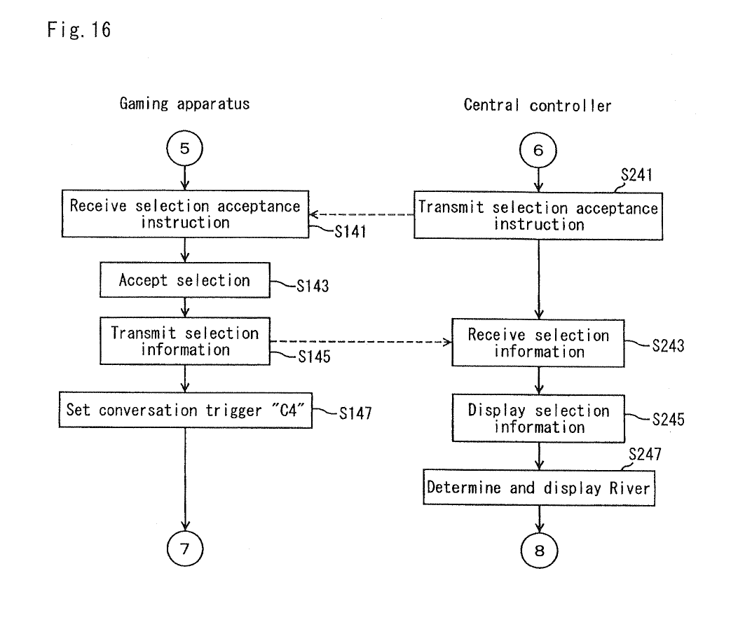

Next, the CPU 41 transmits the selection acceptance instruction signal to the CPU 51 in step S241 in FIG. 16.

On receiving the selection acceptance instruction signal (step S141 in FIG. 16), the CPU 51 included in the gaming apparatus 3 accepts the bet selection (step S143), transmits the selection information to the CPU 41 (step S145) and subtracts a credit corresponding to the betted coin from the credit being stored in the RAM 52.

Next, in step S147, the CPU 51 sets the conversation trigger C4 in the RAM 52. As a result of the conversation trigger C4 being set in the RAM 52, the conversation based on the player's selection of bet, call, raise or fold is started in the gaming apparatus 3.

On the other hand, upon receiving the selection information transmitted from the CPU 51 (step S243), the CPU 41 included in the central controller 40 displays the received selection information to the gaming information display portion 35 in the front display 21 (step S245), and cumulatively adds the number of credits corresponding to the betted coins to the number of credits stored in the RAM 42. Then, the CPU 41 determines a card, which is to be River, and displays the card to the front display 21 (step S247).

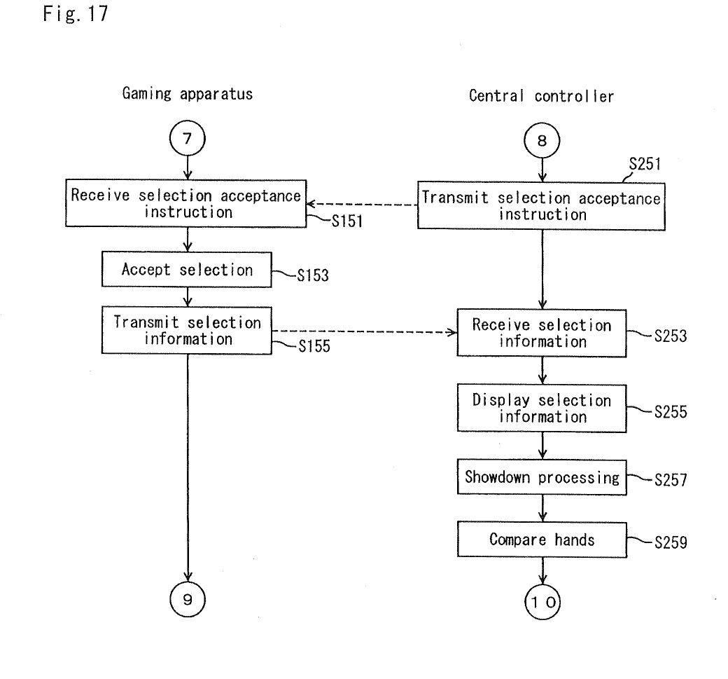

Next, in step S251 in FIG. 17, the CPU 41 transmits the selection acceptance instruction signal to the CPU 51.

Upon receiving the selection acceptance instruction signal (step S151 in FIG. 17), the CPU 51 included in the gaming apparatus 3 accepts a bet selection (step S153), transmits the selection information to the CPU 41 (step S155) and subtracts a credit corresponding to the betted coin from the credit being stored in the RAM 52.

On the other hand, upon receiving the selection information transmitted from the CPU 51 (step S253), the CPU 41 included in the central controller 40 displays the received selection information to the gaming information display portion 35 in the front display 21 (step S255), and cumulatively adds the number of credits corresponding to the betted coins to the number of credits stored in the RAM 42.

Next, in step S257, the CPU 41 conducts showdown processing. More specifically, the CPU 41 displays two cards dealt to the player on each gaming apparatus 3 to the gaming information display portion 35 corresponding to each gaming apparatus 3.

Next, in step S259, the CPU 41 compares hands. More specifically, the CPU 41 determines the strongest hand as a hand of a single player, out of the hands which can be established by combining two cards dealt to the player and three cards among five cards displayed to the table 31 in the front display 21. After conducting the same processing with respect to all the players remaining in the game, the CPU 41 determines the player having the strongest hand by comparing the hands of the respective players.

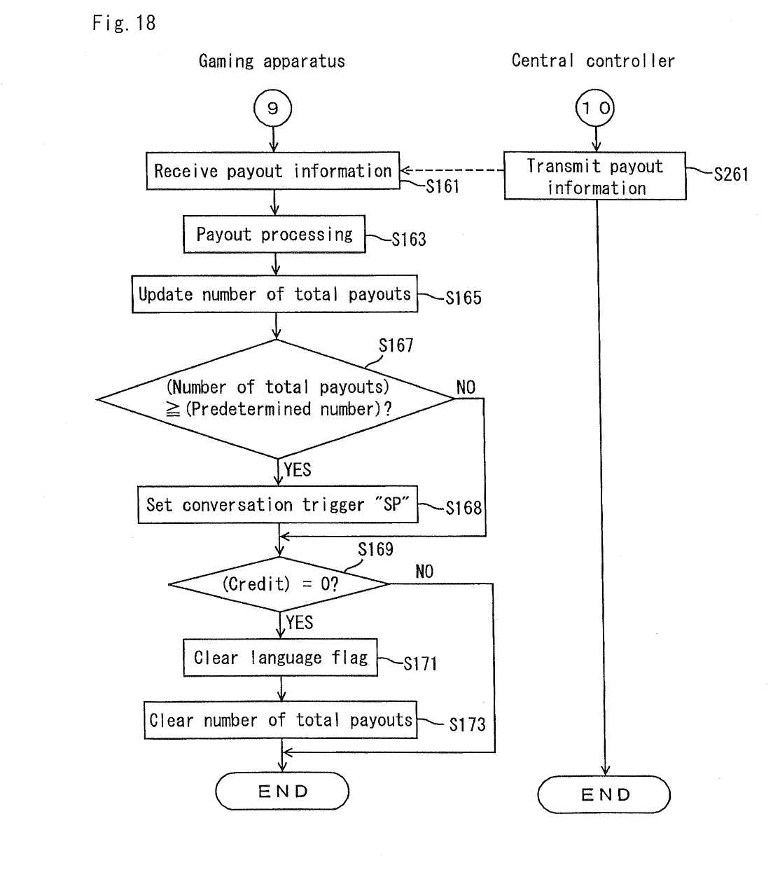

Next, in step S261 in FIG. 18, the CPU 41 transmits information on the number of payouts (hereinafter, also referred to as payout information) to the CPU 51. More specifically, the CPU 41 transmits information on an amount of the credit cumulatively stored in the RAM 42 to the CPU 51. After conducting the processing of step S261, the CPU 41 terminates the game processing according to the central controller 40.

Upon receiving the payout information (step S161), the CPU 51 included in the gaming apparatus 3 pays out a credit based on the received payout information (step S163). Here, in the case that the operation button 12 is pressed, the CPU 51 pays out coins in number corresponding to the number of credits stored in the RAM 52 from the coin payout exit 15.

Next, in step S165, the CPU 51 updates the number of total payouts. In the processing, the CPU 51 adds the number of paid out credits to the number of total payouts.

Next, in step S167, the CPU 51 determines whether or not the number of total payouts is equal to or more than the predetermined number. In the processing, the CPU 51 determines whether or not the number of total payouts becomes equal to or more than the predetermined number for the first time after the reset of the number of total payouts to zero. When determining that the number of total payouts is not equal to or more than the predetermined number, the CPU 51 terminates the present subroutine.

On the other hand, when determining that the number of total payouts is equal to or more than the predetermined number, the CPU 51 sets the conversation trigger SP in the RAM 52. As a result of the conversation trigger SP being set in the RAM 52, a conversation based on the number of total payouts being equal to or more than the predetermined number (in the present embodiment, 1000 or more, or 5000 or more) is started in the gaming apparatus 3.

Next, in step S169, the CPU 51 determines whether or not the credit is zero. When determining that the credit is not zero, the CPU 51 terminates the game processing according to the gaming apparatus 3.

When determining that the credit is zero, the CPU 51 clears the language flag (step S171). Next, the CPU 51 clears the number of total payouts. Then, the CPU 51 terminates the game processing according to the gaming apparatus 3.

FIG. 19 is a flow chart illustrating a language type recognition processing according to the present embodiment.

The language recognition program stored in the ROM 53 is read and executed so as to advance the language type recognition processing.

First, the CPU 51 determines whether or not the smart card is inserted in the card slot 18 (step S300). When determining that the smart card is inserted, the CPU 51 stores a conversation mode stored in the smart card in the language flag storage area 52A in the RAM 52, in addition to setting the conversation mode stored in the smart card in the conversation mode storage area 52G in the RAM 52. Then, the CPU 51 terminates the present subroutine.

Here, in the present embodiment, the conversation mode and the language flag stored in the smart card are written by a staff on the smart card in advance at membership registration and are not rewritable.

When determining that the smart card is not inserted in step S300, the CPU 51 outputs “Hello” in English from the speakers 16 (step S302) and starts measurement of the elapsed time period T (step S303).

Next, in step S304, the CPU 51 determines whether or not a response to “Hello” is inputted from the microphone 17. In the processing, the CPU 51 determines, for example, whether or not “Hello” is inputted from the microphone 17. When determining that a response to “Hello” is inputted from the microphone 17, the CPU 51 stores the language flag of “English” in the language flag storage area 52A (see FIG. 7) in the RAM 52 (step S305).

When determining that a response to “Hello” is not inputted from the microphone 17, the CPU 51 determines whether or not the elapsed time period T exceeds three seconds (step S307). When determining that the elapsed time period T is not exceeding three seconds, the CPU 51 returns the processing to step S304.

When determining that the elapsed time period T is exceeding three seconds, the CPU 51 outputs a voice corresponding to “Hello” in another language “X” (for example, “Japanese”) from the speakers 16 (step S309), and starts measurement of the elapsed time period T (step S311).

Next, in step S313, the CPU 51 determines whether or not a response to “Hello” in another language “X” is inputted from the microphone 17. In the processing, the CPU 51 determines, for example, whether or not “Hello” in another language “X” is inputted from the microphone 17. When determining that a response to “Hello” in another language “X” is inputted from the microphone 17, the CPU 51 stores a language flag “X” in the language flag storage area 52A (see FIG. 7) in the RAM 52 (step S315).

When determining that a response to “Hello” in another language “X” has not been inputted from the microphone 17, the CPU 51 determines whether or not the elapsed time period T exceeds three seconds (step S317). When determining that the elapsed time period T is not exceeding three seconds, the CPU 51 returns the processing to step S313.

After the processing of step S305 or after the processing of step S315, the CPU 51 sets the conversation mode “conversation by voice” in the RAM 52 (step S316).

Next, the CPU 51 determines the conversation speed corresponding to the elapsed time period T at the time when the response is inputted (step S319). In the processing, the CPU 51 determines the conversation speed with reference to the conversation speed determination table (see FIG. 9) stored in the ROM 53. Then, the CPU 51 stores information on the determined conversation speed in the conversation speed storage area 52C (see FIG. 7) in the RAM 52.

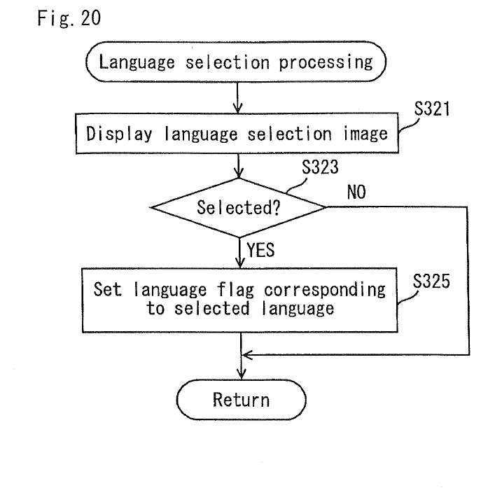

When determining that the elapsed time period T is exceeding three seconds in step S317, the CPU 51 conducts the language selection processing (step S318). The language selection processing will be described later with reference to FIG. 20.

Next, the CPU 51 sets the conversation mode “conversation by sign language” in the RAM 52 (step S320).

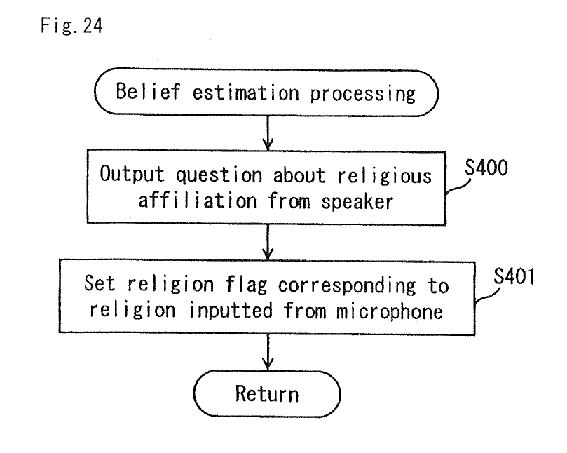

After the processing of step S319 or after the processing of step S320, the CPU 51 conducts belief estimation processing (step S327) and terminates the present subroutine. The belief estimation processing will be described later with reference to FIG. 24.

FIG. 20 is a flow chart illustrating a language selection processing according to the present embodiment.

First, the CPU 51 displays a language selection image to the liquid crystal display 10 (step S321).

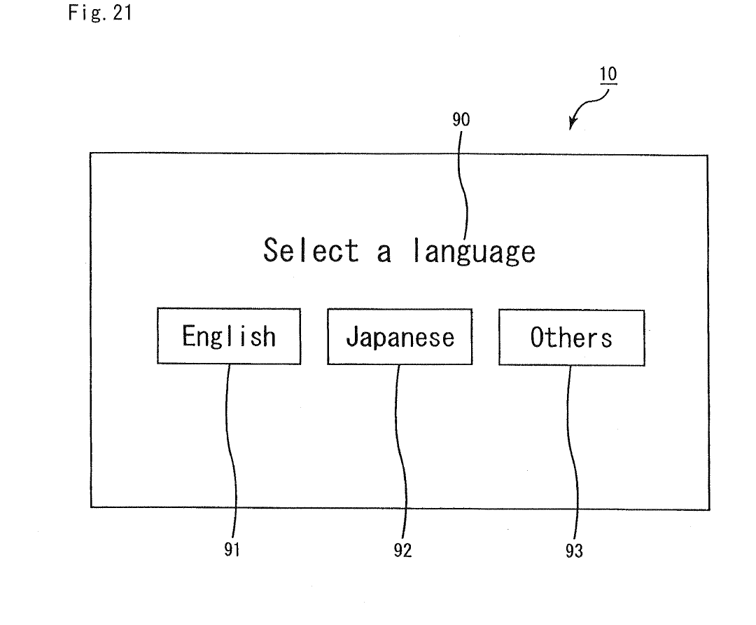

FIG. 21 is an exemplary view showing an image displayed to the liquid crystal display included in the gaming apparatus shown in FIG. 5.

The image shown in FIG. 21 is the language selection image displayed in the processing of step S321. As shown in FIG. 21, to the center part of the liquid crystal display 10, there is displayed an image 90 showing an instruction to select a language type. Further, below the image 90, an English selection image 91 for selecting English as the language type, a Japanese selection image 92 for selecting Japanese as the language type and an Others selection image 93 for selecting a language other than English and Japanese are displayed starting from the left. The player can select the language type by touching a corresponding part on the touch panel 11. Here, in the present embodiment, the language selection image includes the image 90, the English selection image 91, the Japanese selection image 92 and the Others selection image 93. Further, a selection image may be an image using a corresponding language. That is, “Japanese” shown in the Japanese selection image 92 may be displayed in Japanese.

After the processing of step S321, the CPU 51 determines whether or not there has been a selection input (step S323). In the processing, the CPU 51 determines whether or not a contact by the player is detected from the touch panel 11 during a predetermined time period (for example, five seconds) since the language selection image is displayed. The touch panel 11 corresponds to the input device according to the present invention. When determining that there has been the selection input, the CPU 51 stores the language flag corresponding to the selected language type in the language flag storage area 52A (see FIG. 7) in the RAM 52 (step S325). For example, upon detecting a contact by the player to the part corresponding to the English selection image 91 (see FIG. 21) on the touch panel 11, the CPU 51 stores the language flag “English”. Further, upon detecting a contact by the player to the part corresponding to the Japanese selection image 92 (see FIG. 21) on the touch panel 11, for example, the CPU 51 stores the language flag “Japanese”.

Here, when detecting a contact by the player to the part corresponding to the Others selection image 93, the CPU 51 further displays selection images for selecting French, German and the like. Then, when detecting a contact by the player to a part corresponding to a newly displayed selection image, the CPU 51 stores a language flag corresponding to the language in the language flag storage area 52A (see FIG. 7) in the RAM 52.

After the processing of step S325 or when determining that there is no selection input in step S323, the CPU 51 terminates the present subroutine.

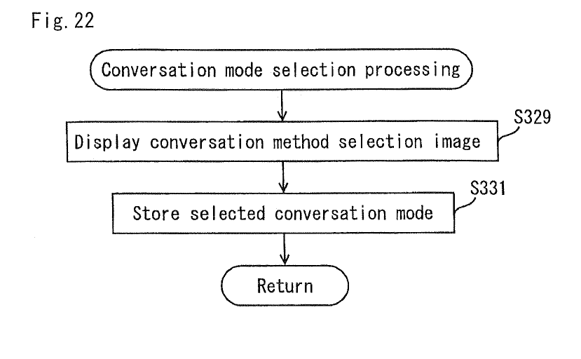

FIG. 22 is a flow chart illustrating conversation mode selection processing according to the present embodiment.

The conversation mode selection processing is processing called and conducted when the player inputs a predetermined operation.

First, in step S329, the CPU 51 displays a conversation method selection image to the liquid crystal display 10.

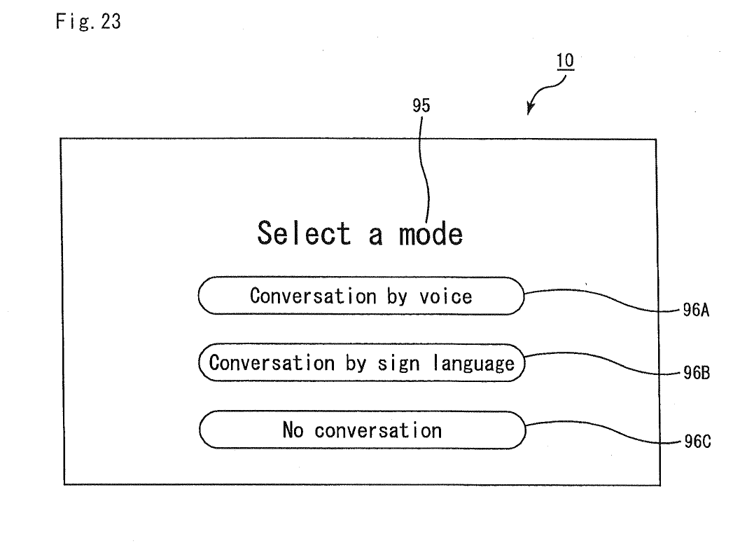

FIG. 23 is an exemplary view showing an image displayed to the liquid crystal display included in the gaming apparatus shown in FIG. 5.

The image shown in FIG. 23 is the conversation method selection image displayed in the processing of step S329.

As shown in FIG. 23, to the upper part of the liquid crystal display 10, an image 95 for instructing the player to select a conversation mode is displayed. Further, below the image 95, a voice conversation image 96A for selecting “conversation by voice”, a display conversation image 96B for selecting “conversation by sign language” and a no conversation image 96C for selecting “no conversation” are displayed starting from the top. The player can select one of the modes by touching a corresponding part on the touch panel 11. The selected mode is stored in the conversation mode storage area 52G in the RAM 52. The image 95, the voice conversation image 96A, a display conversation image 96B and the no conversation image 96C correspond to the selection image according to the present invention.

After the processing of step S329, the CPU 51 stores the selected conversation mode in the conversation mode storage area 52G in the RAM 52 in step S331, and terminates the present subroutine. Here, in the case that “conversation by voice” is selected in step S329, a conversation is conducted by (1) outputting a voice from the speakers 16 and recognizing a voice inputted from the microphone 17. Further, in the case that “conversation by sign language” is selected, a conversation is conducted by (2) displaying to the liquid crystal display an image of sign language relating to the conversation and recognizing a voice inputted from the microphone 17. Furthermore, in the case that “no conversation” is selected, a conversation is (3) not conducted.

FIG. 24 is a flow chart illustrating belief estimation processing according to the present embodiment.

First, the CPU 51 outputs a question about a religious affiliation from the speakers 16 in step S400. In the processing, the CPU 51 outputs, for example, a voice saying “What is your religious affiliation?” from the speakers 16.

Next, in step S401, the CPU 51 stores a religion flag corresponding to the religion, which is inputted from the microphone 17 and recognized, in the belief storage area 52D (see FIG. 7) in the RAM 52. Then, the CPU 51 terminates the present subroutine.

The CPU 51 refers to the religion flag when displaying an image according to the conduct of the game processing (see FIGS. 13 to 18). The CPU 51 omits display of an image, of which display is restricted by the religion flag.

FIG. 25 is a flow chart illustrating conversation processing according to the present embodiment.

The conversation program stored in the ROM 53 is read and executed so as to advance the conversation processing. Further, the conversation processing is a processing called and conducted at a predetermined timing separately from the game processing (see FIGS. 13 to 18).

Here, the conversation processing is conducted in the language corresponding to the language flag stored in the language flag storage area 52A in the RAM 52. Further, the conversation processing is conducted at a speed corresponding to information on the conversation speed stored in the conversation speed storage area 52B in the RAM 52. Further, in the conversation processing, a conversation is conducted following a method based on the conversation mode stored in the conversation mode storage area 52G in the RAM 52. Particularly, in the case that the conversation mode “conversation by sign language” is stored, a program for recognizing the player's sign language is also executed at the same time.

First, in step S500, the CPU 51 determines whether or not a conversation trigger is stored in the conversation trigger storage area 52B in the RAM 52. In the processing, the CPU 51 determines whether or not any of the conversation triggers, out of the conversation triggers C1, C2, C3, C4 and SP, is stored in the RAM 52. When determining that the conversation trigger is not stored in the RAM 52, the CPU 51 terminates the present subroutine.

When determining that the conversation trigger is stored in the RAM 52 in step S500, the CPU 51 outputs a conversational sentence corresponding to the conversation trigger by a method corresponding to the conversation mode, with reference to the conversational sentence selection table stored in the ROM 53 (step S501). More specifically, in the case that the conversation mode is “conversation by voice”, the CPU 51 outputs a voice corresponding to the conversation trigger from the speakers 16. Further, in the case that the conversation mode is “conversation by sign language”, the CPU 51 displays an image of sign language corresponding to the conversation trigger to the liquid crystal display 10. Furthermore, in the case that the conversation mode is “no conversation”, the CPU 51 outputs nothing. At this time, the CPU 51 outputs the conversational sentence after determining the to-be-outputted conversational sentence with reference not only to the conversational sentence selection table, but also to the selection information and to the gaming history according to need.

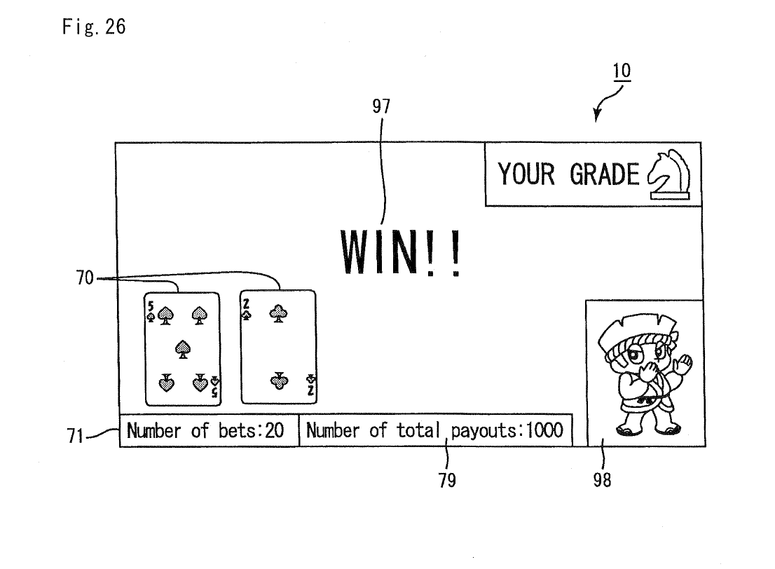

FIG. 26 is an exemplary view showing an image displayed to the liquid crystal display included in the gaming apparatus shown in FIG. 5.

The image shown in FIG. 26 is an image displayed in processing of step S501, in the case that the conversation mode is “conversation by sign language”. As shown in FIG. 26, to the lower right part of the liquid crystal display 10, an image 98 of sign language relating to the conversation is displayed. Further, to the center part of the liquid crystal display 10, an image 97 indicating that the player wins the game is displayed.

Next, in step S503, the CPU 51 recognizes a voice inputted from the microphone 17. In the processing, the player's sign language is recognized by motion capture using the image captured by the camera 20, in addition to recognizing a voice inputted from the microphone 17, in the case that the conversation mode is “conversation by sign language”.

Then, the CPU 51 outputs from the speakers 16 a voice corresponding to the recognized content, or displays an image of sign language corresponding to the recognition to the liquid crystal display 10, and then, carries the conversation with the player on by recognizing the voice inputted from the microphone 17 or by recognizing the player's sign language captured by the camera 20 (step S505).

Next, in step S507, the CPU 51 determines whether or not there is a new conversation trigger being set or the conversation trigger being cleared. In the case that a new conversation trigger is not set and the conversation trigger is not cleared, the CPU 51 returns the processing to step S505 and continues the conversation. On the other hand, in the case that a new conversation trigger is set or the conversation trigger is cleared, the CPU 51 terminates the present subroutine.

Accordingly, the CPU 51 starts a conversation when a conversation trigger is set, starts another conversation on a new topic when a new conversation trigger is set, and terminates the conversation when the conversation trigger is cleared.

According to the gaming apparatus 3 and the control method of the gaming apparatus 3, a conversation with the player is conducted based on the execution of a conversation program corresponding to the recognized language. Therefore, it becomes possible for the player to play a game while enjoying the conversation. Particularly, on a gaming apparatus 3 providing a game played by a single player (game not advanced by cooperation with another player), it is highly possible that the player feels loneliness. However, by conducting a conversation, it becomes possible to dispel the loneliness.

As above described, according to the gaming apparatus 3 and the control method of the gaming apparatus 3, it becomes possible to provide a sophisticated service by installing a conversation program on a gaming apparatus 3.

Further, according to the gaming apparatus 3 and the control method of the gaming apparatus 3, an elapsed time period T since the voice relating to the conversation is outputted from the speakers 16 is measured. Then, the gaming apparatus 3 conducts the conversation with the player by recognizing a voice inputted from the microphone 17 or by recognizing the player's sign language captured by the camera 20, in addition to displaying to the liquid crystal display 10 an image of sign language, instead of outputting a voice from the speakers 16, in the case that a response to the voice relating to the conversation is not determined to be inputted and the elapsed time period T exceeds a predetermined time period (in the present embodiment, three seconds).

In the case that there is no response to the voice relating to the conversation outputted from the speakers 16 over the predetermined time period, it is highly possible that the player does not hear the voice relating to the conversation. Namely, it is highly possible that the player has weak hearing. In the gaming apparatus 3, the conversation is conducted with such a player by displaying an image of sign language relating to the conversation to the liquid crystal display 10. Accordingly, it becomes possible even for a player with weak hearing to enjoy a conversation.

As above described, according to the gaming apparatus 3 and the control method of the gaming apparatus 3, it is possible to solve problems newly generated in the case that a conversation program is installed on a gaming apparatus, namely, a problem that how to recognize a player with weak hearing and a problem that how to entertain the player with weak hearing.

Even among the players not with weak hearing, there may be a player who does not want another player to listen to the voice outputted from the gaming apparatus, although the player wants to enjoy the conversation. However, according to the gaming apparatus 3, in the case that there is an input to conduct the conversation by display from the touch panel 11, the gaming apparatus 3 conducts the conversation with the player by recognizing the voice inputted from the microphone 17, in addition to displaying an image of sign language relating to the conversation to the liquid crystal display 10, instead of outputting the voice from the speakers 16. Accordingly, it becomes possible for the player to enjoy the conversation without having another player listen to the voice outputted from the gaming apparatus 3.

According to the gaming apparatus 3, a selection image (image 95, voice conversation image 96A, display conversation image 96B and no conversation image 96C) to prompt the player to select whether or not to conduct the conversation by sing language is displayed to the liquid crystal display 10, in the case that the elapsed time period T exceeds a predetermined time period. Then, in the case that there is an input to conduct the conversation by display from the touch panel 11, the gaming apparatus 3 conducts the conversation with the player by recognizing a voice inputted from the microphone 17, in addition to displaying an image of sign language relating to the conversation to the liquid crystal display 10, instead of outputting a voice from the speakers 16. Since the selection image is displayed to the liquid crystal display 10, the player with weak hearing can surely recognize that the conversation is conducted by sign language.

According to the gaming apparatus 3, in the case that the conversation mode “conversation by sign language” is determined to be read from the smart card, the conversation with the player is conducted by recognizing a voice inputted from the microphone 17, in addition to displaying a text relating to the conversation to the liquid crystal display 10, instead of outputting a voice from the speakers 16.

Since the conversation by text is conducted in the case that the conversation mode “conversation by sign language” is determined to be read from the smart card, the player with weak hearing can have the conversation mode “conversation by sign language” read from the smart card so that the conversation by text is conducted. As a result, the player can surely enjoy the conversation.

In the present embodiment, there has been described a case where a controller (CPU) which conducts the game processing also conducts the conversation processing. However, the present invention is not limited to this example. A controller (CPU) for conducting the game processing and a controller (CPU) for conducting the conversation processing may be provided separately. In such a configuration, the controller for conducting the conversation processing may receive various kinds of information (for example, information on the selection information, the gaming history, the language flag, the conversation trigger and the conversation speed, information on the player's belief, the number of total payouts and the like) from the controller for conducting the game processing, and may conduct the conversation processing based on these information.

In the present embodiment, there has been described a case where specific data of the present invention is the conversation mode “conversation by sign language”. However, the present invention is not limited to this example. The specific data may be data indicating a weak hearing, or alternatively, the specific data may be ID data for specifying the player. In the case of employing such a configuration, the conversation mode “conversation by display” may be set in the gaming apparatus, when the data indicating a weak hearing or specific ID data is read.

Although the embodiments of the present invention have been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications.

Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming apparatus comprising:
a microphone;
a speaker;
a display; and
a controller,
said controller programmed to conduct the processing of:
(A) conducting a conversation with a player by recognizing a voice inputted from said microphone, in addition to outputting a voice relating to the conversation from said speaker by executing a conversation program;
(B) measuring an elapsed time period since said voice relating to the conversation is outputted from said speaker;
(C) determining whether or not a response to said voice relating to the conversation is inputted from said microphone; and
(D) conducting the conversation with the player by recognizing the voice inputted from said microphone, in addition to displaying to said display an image of sign language relating to the conversation, instead of conducting said processing (A), in the case that said elapsed time period exceeds a predetermined time period without said response determined to have been inputted in said processing (C).

2. The gaming apparatus according to claim 1 comprising
an input device,
wherein
said controller is further programmed to conduct the processing of:
(E) conducting the conversation with the player by recognizing the voice inputted from said microphone, in addition to displaying to said display the image of sign language relating to the conversation, instead of conducting said processing (A), in the case that there is an input to conduct the conversation by sign language from said input device.

3. The gaming apparatus according to claim 1 comprising
an input device,
wherein
said processing (D) includes:
(D-1) displaying to said display a selection image to prompt the player to select whether or not to conduct the conversation by sign language, in the case that said elapsed time period exceeds the predetermined time period; and
(D-2) conducting the conversation with the player by recognizing the voice inputted from said microphone, in addition to displaying to said display the image of sign language relating to the conversation, instead of conducting said processing (A), in the case that there is an input to conduct the conversation by sign language from said input device.

4. The gaming apparatus according to claim 1 comprising a card reader capable of reading data from a removable card,
wherein
said controller is further programmed to conduct the processing of
(F) conducting the conversation with the player by recognizing the voice inputted from said microphone, in addition to displaying to said display the image of sign language relating to the conversation, instead of conducting said processing (A), when determining that specific data is read from said removable card through said card reader.

5. A gaming apparatus comprising:
a microphone;
a speaker;
a display;
a card reader capable of reading data from a removable card; and
a controller,
said controller programmed to conduct the processing of:
(A) conducting a conversation with a player by recognizing a voice inputted from said microphone, in addition to outputting a voice relating to the conversation from said speaker by conducting a conversation program;
(B) reading data from said removable card through said card reader; and
(C) conducting the conversation with the player by recognizing the voice inputted from said microphone, in addition to displaying to said display an image of sign language relating to the conversation, instead of conducting said processing (A), when determining that the read data in said processing (B) is specific data.

6. A gaming apparatus comprising:
a microphone;
a speaker;
a display;
a camera for capturing a form and/or a motion of a hand of a player; and
a controller,
said controller programmed to conduct the processing of:
(A) conducting a conversation with the player by recognizing a voice inputted from said microphone, in addition to outputting a voice relating to the conversation from said speaker by conducting a conversation program;
(B) measuring an elapsed time period since said voice relating to the conversation is outputted from said speaker;
(C) determining whether or not a response to said voice relating to the conversation is inputted from said microphone; and
(D) conducting the conversation with the player by recognizing the form and/or the motion of the hand of the player captured by said camera, in addition to displaying to said display an image of sign language relating to the conversation, instead of conducting said processing (A), in the case that said elapsed time period exceeds a predetermined time period without said response determined to have been inputted in said processing (C).

7. A gaming apparatus comprising:
a microphone;
a speaker;
a display;
a card reader capable of reading data from a removable card; and
a controller,
said controller programmed to conduct the processing of:
(A) conducting a conversation with a player by recognizing a voice inputted from said microphone, in addition to outputting a voice relating to the conversation from said speaker by conducting a conversation program;
(B) reading data from said removable card through said card reader; and
(C) conducting the conversation with the player by recognizing a form and/or a motion of a hand of a player captured by a camera, in addition to displaying to said display an image of sign language relating to the conversation, instead of conducting said processing (A), in the case that the data read in said processing (B) is determined to be specific data.

8. A control method of a gaming apparatus, said control method comprising the step of:
(A) conducting a conversation with a player by recognizing a voice inputted from a microphone, in addition to outputting a voice relating to the conversation from a speaker by executing a conversation program;
(B) measuring an elapsed time period since said voice relating to the conversation is outputted from said speaker;
(C) determining whether or not a response to said voice relating to the conversation is inputted from said microphone; and
(D) conducting the conversation with the player by recognizing the voice inputted from said microphone, in addition to displaying to a display a text relating to the conversation, instead of conducting said step (A), in the case that said elapsed time period exceeds a predetermined time period without said response determined to have been inputted in said step (C).

9. A control method of a gaming apparatus, said control method comprising the step of:
(A) conducting a conversation with a player by recognizing a voice inputted from a microphone, in addition to outputting a voice relating to the conversation from a speaker by conducting a conversation program;
(B) reading data from a removable card through a card reader; and
(C) conducting the conversation with the player by recognizing the voice inputted from said microphone, in addition to displaying to a display a text relating to the conversation, instead of conducting said step (A), when determining that the read data in said step (B) is specific data.
